(19) United States
(12) Patent Application Publication
(10) Pub. No.: US 2017/0339264 A1
(43) Pub. Date: Nov. 23, 2017

(54) SYSTEMS AND METHODS FOR CROSS-MODALITY COMMUNICATION

(71) Applicant: Nir STEEL, Lauderhill, FL (US)

(72) Inventors: Nir STEEL, Lauderhill, FL (US); David OHAYON, Petah Tikva (IL)

(21) Appl. No.: 15/523,059

(22) PCT Filed: Oct. 28, 2015
(86) PCT No.: PCT/IL15/51058

§ 371 Date: Apr. 28, 2017

Related U.S. Application Data
(60) Provisional application No. 62/069,409, filed on Oct. 28, 2014.

(51) Int. Cl. H04M 1/2745; H04L 12/58

(52) U.S. Cl. CPC H04M 1/274508; H04L 51/32; H04M 1/27455

(57) ABSTRACT

A multi-modality electronic communication method for communication via end-user selected communication modalities, including (at a server, having access to memory table/s operative to store, for each end user from among a multiplicity thereof, destinations via which the individual end user receives communications via a corresponding plurality of communication modalities): receiving communication/s from Tx client processor/s serving a Tx end user, the communication including content the Tx end user wishes to send to an Rx end user; and an indication of a known destination of an Rx end user, when a first communication modality is employed; extracting the known destination from the communication and retrieving from the table, a retrieved destination other than the known destination via which the Rx end user receives communications via a second communication modality; and sending the content to the Rx end user via the second communication modality to the retrieved destination.

### CROSS-REFERENCE TO RELATED APPLICATIONS

This application claims priority from U.S. Ser. No. 62/069,409, entitled “A System and Method of Electronic Communication of Addressing, Identifying and/or Associating a Social Media Account, Web or Email Address to a Character” and filed 28 Oct. 2014.

### FIELD OF THIS DISCLOSURE

The present invention relates generally to computerized systems and more particularly to computerized systems for electronic communication.

### BACKGROUND FOR THIS DISCLOSURE

The quality and quantity of modes for identifying, locating, and communicating electronically, with both individuals and entities, have advanced significantly in recent years. Communicating via phone, text, webpage, and tweet have become an absolute necessity in today's fast-paced, always-connected society. Current technology allows one to store and scroll through separate electronically-sortable databases on a mobile device for unique phone numbers, email addresses, social media identifiers, and web addresses. While you can store a unique phone number, email address, social media and web contact information in one place organized by an individual's or entity's name, accessing and communicating with another via these different types of media requires separate and distinct communication channels, e.g. the phone number, the email address, the web address, and the social media handle. Moreover, a web address, email address, and phone number each contain multiple characters, that can often not be related to each other in terms of characters, that are difficult to remember and accurately input into a device such as a phone or web browser.

Furthermore, while an individual's phone number is embedded into a mobile device via one's active phone service, to send that same person an email or access his webpage or social media account requires knowledge of those account addresses and access to each networked remote server separately. As such, to contact, communicate with, and follow the same individual or entity via the various methods that have become mandatory in today's society, requires traveling through separate and distinct channels of multiple communication networks, each of which requires the entry of multi-character data unique to that individual or entity. According to certain embodiments the user may identify and communicate with another user over a myriad of channels, including but not limited to, phone, text, email, web, and social media, by one unique identifying character or combination of characters.

According to certain embodiments a user may maintain one identifying character or combination of characters as a manner of connecting with that user by email, phone, text, web, and/or social media. Thus, it may eliminate the need to keep separate databases for an individual's contact information. All contact information may be one-touch accessible via a distinct identifying character(s), pictures, or data associated with the contact linked together via novel software embedded within the mobile device.

State of the art systems for facilitating electronic communications between end users include those described in the following US patents: U.S. Pat. No. 8,600,343; U.S. Pat. No. 7,873,356; U.S. Pat. No. 7,925,620; U.S. Pat. No. 8,755,772; US20030200210; U.S. Pat. No. 8,843,582; U.S. Pat. No. 8,661,002; U.S. Pat. No. 7,873,356; and U.S. Pat. No. 8,589,820; U.S. Pat. No. 8,661,002; U.S. Pat. No. 7,873,356; U.S. Pat. No. 8,589,820; U.S. Pat. No. 8,726,165.

State of the art systems for facilitating electronic communications between end users include those described in the following published US patent applications: US20140156644; US20100299352; US20060047725; US20030200210; US20140181084; and in the following published PCT patent application: WO2001008432.

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

Certain embodiments of the present invention seek to provide a system and method for electronic communication of addressing, identifying and/or associating a social media account, web or email address to a character.

Certain embodiments seek to provide software embedded within an electronic communications device that consolidates different communication channels and streamlines the ability to interact with others, and a method of using the software to communicate with others.

The following configurations are provided inter alia:

Configuration 1: A system of using an electronic device to address, identify and/or associate a social media account, web or email address to a character comprising:
an electronic device having communication properties; and
software which is configured to address, identify and/or associate a web or email address with at least one character via a server communication;
whereas a user selects any data representing the at least one character into the electronic device and data of any format is sent to or received from the associated or operated web or email address by way of the communication properties of the electronic device.

Configuration 2: The system of Configuration 1, wherein the at least one character is more than one character and may include alphabetic or numerical characters as well as images or combinations of alphanumeric characters, numerical characters, and images and may include a specialized character to designate communication to this server.

Configuration 3: The system of Configuration 2, wherein the numerical characters are a phone number.

Configuration 4: The system of Configuration 3, wherein the phone number may include a prefixed country or area code.

Configuration 5: The system of Configuration 1, wherein the data is text, video, audio, web-based, or photography data.

Configuration 6: The system of Configuration 1, wherein the electronic device is a mobile phone, computer, tablet, personal digital assistant, or any similar electronic device.

Configuration 7: The system of Configuration 1, wherein communication properties may include cellular communication, wired or wireless Internet communication, or any similar mobile communication technology.

Configuration 8: The system of Configuration 1, wherein the software is configured to store, manage, send, or receive email at any form of data interpreted as a numerical character.

Configuration 9: The system of Configuration 2, wherein the software can send and/or receive email or web addresses associated to a numeric character in any data format.

Configuration 10: The system of Configuration 2, wherein the software can identify, store, address or associate and operate a web address at a numerical character any data format.

Configuration 11: The system of Configuration 1 wherein the character represents an email or web address.

Configuration 12: A method of using an using an electronic device to identify, or operate, address and/or and associate a social media account, web or email address to a character comprising:
selecting data representing a character into an electronic device having communication properties; and
using software configured to address, associate an web or email address with at least one character via a server communication;
whereas by entering the numerical character, a user can send and/or receive data of any format to or from the addresses or associated with web or email address by way of the communication properties of the electronic device.

Configuration 13: The method of Configuration 12, wherein the at least one character is more than one numerical character and may include images or combinations of images and numerical characters in any data format which may include a specialized character to designate communication to this server.

Configuration 14: The method of Configuration 13, wherein the numerical characters are a phone number.

Configuration 15: The method of Configuration 14, wherein the phone number may include a prefixed country or area code.

Configuration 16: The method of Configuration 12, wherein the data is text, video, audio, web-based or photography data.

Configuration 17: The method of Configuration 12, wherein the electronic device is a mobile phone, computer, tablet, personal digital assistant, or any similar electronic device.

Configuration 18: The method of Configuration 12, wherein communication properties may include cellular communication, wired or wireless Internet communication, or any similar mobile communication technology.

Configuration 19: The method of Configuration 12, wherein the software is configured to store, manage, send, or receive email with any other form of data at a numerical character.

Configuration 20: The method of Configuration 12, wherein the software can send and/or receive email with any other form of data at a numerical character.

Configuration 21: The method of Configuration 12, wherein the software can identify, store, and operate a web address with any form of data at a numerical character.

Configuration 22: The method of Configuration 12 wherein the character represents an email or web address.

Configuration 23: A system of developing an address book to address, identify and/or associate a web or email address to a character comprising:
software being configured to address, identify and/or associate an web or email address with at least one character via a server communication;
whereas a user selects any data representing the at least one character into the electronic device and data of any format is sent to or received from the associated or operated web or email address by way of the communication properties of the electronic device.

The present invention typically includes at least the following embodiments:

### Embodiment 1

A multi-modality electronic communication method for communication via end-user selected communication modalities, the method comprising:

at a server,

the server including a processor having access to at least one memory table operative to store, for each individual end user from among a multiplicity of end users, a plurality of destinations via which the individual end user receives communications via a corresponding plurality of communication modalities;

receiving at least one communication from at least one Tx client processor serving a Tx end user, the communication including:
content which the Tx end user wishes to send to an Rx end user; and
an indication of a known destination of an Rx end user, when a first communication modality is employed:

extracting the known destination from the communication and retrieving from the table, a retrieved destination other than the known destination via which the Rx end user receives communications via a second communication modality other than the first communication modality; and

sending the content to the Rx end user via the second communication modality to the retrieved destination.

### Embodiment 2

A method according to any of the preceding embodiments wherein the first communication modality comprises cellphone communication and the known destination when the first communication modality is used, comprises the Rx end user's cellphone number.

### Embodiment 3

A method according to any of the preceding embodiments wherein the second communication modality comprises email, and the retrieved destination comprises the Rx end user's email address.

### Embodiment 4

A method according to any of the preceding embodiments wherein the at least one communication from at least one Tx client processor is received via at least one of the following channels: email, text messaging, url, API.

### Embodiment 5

A method according to any of the preceding embodiments wherein the server includes at least one email server configured for accepting emails within a domain

The system shown and described herein is typically web based. The server may include domain controller/s configured to control the domain. Any suitable domain controller, such as a Windows or Samba server, may be employed to manage security-related aspects of the domain. Any suitable email service may be used with the domain such as but not limited to Google Apps or fastmail. Any suitable technology may be employed for mailbox creation in accordance with teachings provided herein. Any suitable technology may be employed for e-mail transfer and retrieval e.g. POP3 may provide e-mail retrieval, and SMTP may provide e-mail transfer. POP3 or any other service may be employed to store and manage e-mail accounts on the mail server. Email users may use any suitable e-mail client such as Microsoft Outlook or any other that supports a suitable protocol such as but not limited to the POP3 protocol. The mail server may comprise a member server or domain controller. Computers joined to the domain may communicate with the domain controller over any suitable connection e.g. VPN or Internet. Any suitable characteristic of the domain's User account/s and/or password/s may be managed centrally by the domain controller/s in order to implement aspects of the embodiments shown and described herein.

Aspects of the embodiments shown and described herein may for example be implemented by setting suitable group policy settings on the domain controller e.g. using a Local Group Policy editor. Aspects of the embodiments shown and described herein may for example be implemented by suitably setting any of all of: Computer Configurations, User Configuration, Software Settings, Administrative Templates, Windows Settings e.g. some or all of security settings scripts for logon/logoff and scripts for startup/shutdown.

### Embodiment 6

A method according to any of the preceding embodiments wherein the Tx client processor sends a plurality of email messages to a plurality of email addresses all having the domain as a suffix and having prefixes respectively indicative of a corresponding plurality of known destinations of a corresponding plurality of Rx end users.

### Embodiment 7

A method according to any of the preceding embodiments characterized in that a plurality of email messages is routed to a single email account in the domain.

### Embodiment 8

A method according to any of the preceding embodiments wherein the memory table stores, for at least some destinations to be retrieved, an indication of whether the destinations are private and cannot be revealed to a registered Tx end user or public hence can be revealed to a registered Tx end user.

### Embodiment 9

A method according to any of the preceding embodiments wherein second communication modality comprises sending an email originated by a Tx user and intended for an Rx user, and wherein, for each private destination, the sending comprises setting the email's sender to be an email address whose suffix is a domain associated with the server and whose prefix is indicative of a destination of the Rx user which is known to the Tx user.

### Embodiment 10

A method according to any of the preceding embodiments wherein second communication modality comprises sending an email originated by a Tx user and intended for an Rx user, and wherein, for each public destination, the sending comprises using a legacy email program associated with the Tx client processor to send the email.

### Embodiment 11

A method according to any of the preceding embodiments wherein if the Rx user sends to the server, reply content intended for the Tx user, via the Rx user's client processor and the Tx user's email address is private, the server is configured to send a reply email, including the reply content, to the Tx user, including setting the reply email's sender to be an email address whose suffix is a domain associated with the server and whose prefix is indicative of a destination of the Tx user which is known to the Rx user.

### Embodiment 12

A method according to any of the preceding embodiments wherein all of the prefixes are generated from the known destinations using a single rule known to the server such that the known destinations can be derived from the prefixes by the server without pre-storing associations between prefixes and known destinations.

For example, the rule may be that the email address's prefix is identical to the known cellphone number of the email addressee, as described herein.

### Embodiment 13

A method according to any of the preceding embodiments wherein the single email account comprises a catch-all email account.

### Embodiment 14

A method according to wherein the single email account comprises a catch-error email account.

### Embodiment 15

A method according to any of the preceding embodiments and also comprising sending at least one communication from the Tx end user to a single destination at the server, wherein the single destination is operative to receive all communications including an intended destination defined by applying a predetermined rule to a unique Tx end user identifier.

### Embodiment 16

A method according to any of the preceding embodiments wherein the communication comprises an email communication having a “to” field, the destination comprises a default auto email, and the intended destination includes an indication, in the “to” field, of a function of a unique Tx end user identifier.

### Embodiment 17

A method according to any of the preceding embodiments wherein the receiving an indication of a known destination comprises receiving a “reply” generated by an end user using an app associated with the server which is operative to send communications to end users and to provide the end users with a “reply” option.

### Embodiment 18

A method according to any of the preceding embodiments wherein the “reply” option comprises a “call” virtual button thereby enabling an end user who has received a communication via the app to initiate a responsive telephone call by a single click and wherein, responsive to pressing of the “call” virtual button by at least one first end user who has received a communication via the app from a second end user, the system server accesses a telephone number of the second end user and interacts with the first end user's communication device to establish a telephone call from the first user to the second user.

### Embodiment 19

A multi-modality electronic communication system for communication via end-user selected communication modalities, the system comprising:

computer-implemented memory including at least one memory table operative to store, for each individual end user from among a multiplicity of end users, a plurality of destinations via which the individual end user receives communications via a corresponding plurality of communication modalities:

a server including a processor configured to access the at least one table and operative for:

receiving at least one communication from at least one Tx client processor serving a Tx end user, the communication including:
content which the Tx end user wishes to send to an Rx end user; and
an indication of a known destination of an Rx end user, when a first communication modality is employed,

extracting the known destination from the communication and retrieving from the table, a retrieved destination other than the known destination via which the Rx end user receives communications via a second communication modality other than the first communication modality; and

interacting with communication equipment operative in accordance with the second communication modality so as to cause the communication equipment to send the content to the Rx end user via the second communication modality to the retrieved destination.

### Embodiment 20

A computer program product, comprising a non-transitory tangible computer readable medium having computer readable program code embodied therein, the computer readable program code adapted to be executed to implement a multi-modality electronic communication method for communication via end-user selected communication modalities, the method comprising:

at a server including a processor having access to at least one memory table operative to store, for each individual end user from among a multiplicity of end users, a plurality of destinations via which the individual end user receives communications via a corresponding plurality of communication modalities:

receiving at least one communication from at least one Tx client processor serving a Tx end user, the communication including:
content which the Tx end user wishes to send to an Rx end user; and
an indication of a known destination of an Rx end user, when a first communication modality is employed;

extracting the known destination from the communication and retrieving from the table, a retrieved destination other than the known destination via which the Rx end user receives communications via a second communication modality other than the first communication modality; and

sending the content to the Rx end user via the second communication modality to the retrieved destination.

Also provided, excluding signals, is a computer program comprising computer program code means for performing any of the methods shown and described herein when said program is run on at least one computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs. EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIG. 1 depicts a view of an electronic device embedded with the software, according to certain embodiments.

FIG. 2 depicts an alternate view of an electronic device embedded with the software as an email default box, according to certain embodiments.

FIG. 3 depicts a view of a phone number an embedded web page, according to certain embodiments.

FIG. 4 depicts a view of a phone number with a link to an existing webpage, according to certain embodiments.

FIG. 5 depicts a view of a phone number with a link to an email address, according to certain embodiments.

FIG. 6A depicts a view of the electronic device showing a phone number and the options associated for contacting the recipient having that phone number, according to certain embodiments.

FIG. 6B depicts an alternate view of the electronic device showing a phone number and the options associated for contacting the recipient having that phone number, according to certain embodiments.

FIG. 7 depicts the system for using a numerical character, like the phone number, and using it to send and address it to a recipient's email, which may be unknown to the sender, according to certain embodiments.

FIG. 8 depicts server communication methods such as Internet or direct connect, according to certain embodiments.

FIGS. 9a, 9b depict screen shots of associating a phone number to an email address and also a web address, according to certain embodiments.

FIG. 9c depicts a specialized character before a phone number to indicate that the phone number also is associated with other known information about a recipient, according to certain embodiments.

FIG. 10 is a flow chart of a method of operation according to certain embodiments in which information regarding a user is stored on a server.

FIG. 11 is a flow chart of a method a user may employ according to certain embodiments to send to a recipient when utilizing information stored on the server when an email is desired to be sent by addressing the recipient's phone number.

FIG. 12 is a flow chart of the operations a user would perform to reach a recipient when accessing information stored on the server when a web address is desired to be accessed by addressing the recipient's phone number, according to certain embodiments.

FIGS. 13a-13b, 14a-14c, 15a-15c, 16, 17a-17c, 18a-18b and 19a-19b are diagrams exemplifying certain embodiments of the present invention.

FIGS. 20-22 are tables exemplifying certain embodiments of the present invention; some or all of the rows and columns shown may be provided.

FIGS. 23-31 are simplified flowchart illustrations exemplifying certain embodiments of the present invention.

Methods and systems included in the scope of the present invention may include some (e.g. any suitable subset) or all of the functional blocks shown in the specifically illustrated implementations by way of example, in any suitable order e.g. as shown.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

Certain embodiments include a software system embedded within an electronic device, such as a mobile phone, tablet, or similar electronic communications device, which consolidates the various modes of communicating with another by phone, email, web, and social media into a communication channel with an easy to identify unique character or characters.

A system of using an electronic device to address, identify and/or associate a web or email address or application to a character is now described and may include:

an electronic device having communication properties; and

software is configured to address, store, identify and/or associate an web or email address with at least one character via a server communication;

whereas a user selects any desired data representing the at least one character into the electronic device and data of any format is sent to or received from the associated or operated or embedded web or email address by way of the communication properties of the electronic device. In an alternate embodiment, a method is provided for using an electronic device to identify, or operate, address and/or and associate a web or email address or application to a numeric character comprising:

entering data representing a character into an electronic device having communication properties; and

using software configured to address, associate an web or email address with at least one numerical character via server communication:

whereas by entering the character, a user can send and/or receive data of any format to or from the addresses or associated with web or email address by way of the communication properties of the electronic device.

The at least one character is more than one character and may also include an alphabetic or numerical set of characters as well as images or a combination of images and alphanumeric or numeric characters. Common characters may include a phone number, but are not limited to this grouping of characters.

The alphabetic or numerical set of characters, as well as images or a combination of images and alphanumeric or numeric characters, may be prefixed by a specialized symbol that indicates that these characters should be associated with the server for further communication. Such a symbol may be *, @, or any similar symbol. This specialized character may indicate apparatus to display, such a grouping of characters.

Data may comprise any text, video, web-based, voice, or photography data. Data may include any type of data that can be transmitted by an electronic device.

The electronic device may include, but is not limited to a mobile phone, computer, tablet, personal digital assistant, or any similar device. This electronic device must have communication properties that enable the device to send or receive information or data. The electronic device must also be capable of communicating with other electronic devices.

Communication properties include cellular communication, wired, or wireless Internet communication, or any similar mobile communication apparatus.

The software is typically configured to store, manage, sort, send, or receive phone calls, emails text messages, web addresses, and social media accounts. The software is housed on the electronic device and communicates with a server that has linked a user's email address, phone number, web address, and/or social media handle to the characters.

To communicate with another user, a user may enter the desired characters representing the other users' identification into the software housed within his/her electronic device. The desired characters are processed by a server that has already linked and stored user's email address, phone number, web address, and/or social media handle to the characters. This server may be internal or external to the electronic device. This allows a user to send any type of message or data to a recipient through the addressing characters entered. A user does not need to know all information associated with a recipient as entering any identifying characteristics (i.e. phone number), may be processed and associated with the recipient by the server so that the user can send any type of message or data to the recipient. The data or message capable of being transmitted via the software is either text, email, video, audio, images, or a combination thereof. Similarly, one may not need to know the web address or social media page and can browse and communicate to such by merely entering the data or characters stored by the addressee on the server.

However, a recipient does not need to have the software shown and described herein in order to receive what the sender has sent. In an instance where a recipient does not have the software shown and described herein, the received message may include details on how to obtain the software. However, obtaining the software is not required.

Conventional address books that serve as sources of information for locating a person or company may not associate some information with other modes of communication. An address book can be built according to certain embodiments of the invention.

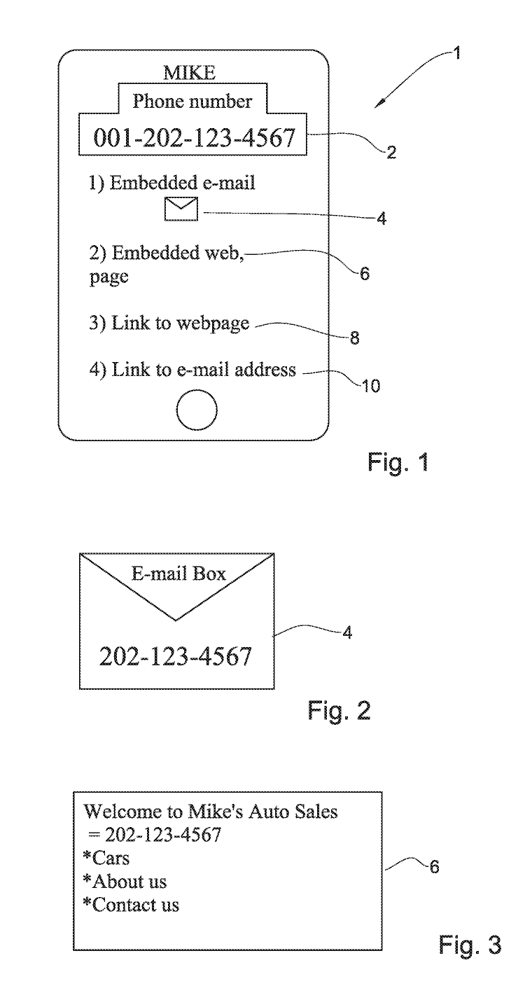

Reference is made to FIG. 1 in which, at reference numeral 4, a first communication modality e.g. embedded e-mail, is addressed as, e.g. may be associated in memory with, the phone number or other “anchoring” communication modality (reference numeral 2), for example 202-123-4567, or may be associated directly with a unique end user ID. A name, such as “Mike”, can also be entered for identification. At reference numeral 6, a second communication modality e.g. embedded web page (or, according to certain embodiments, preset data/profile), is provided, which is addressed to a desired phone number to be reached e.g. 202-123-4567 (address data). At reference numeral 8, a third communication modality e.g. a Link to a web page, may be provided, e.g. if not embedded on the device, for example 202-123-4567=www.mikesauto-sales.com or owner's Facebook page. At reference numeral 10, a fourth communication modality e.g. a Link to an e-mail address, may be provided, if not embedded on the device, for example 202-123-4567=mike123@yahoo.com.

As shown in FIG. 1, the method of using an electronic device, such as a mobile phone (1), embedded with software, may be accomplished by selecting an identifying character (2). This character (2) may be more than one character (2) and may be seen as a phone number, as depicted in FIG. 1. While a phone number is a common unique identifying string of characters, other characters may be similarly used. As seen in FIGS. 1-6B, once a user has entered identifying characters (2), these characters (2) are processed by the software and provide the user with access to text (16) email (4), call (14), view a website (6, 8), or contact a recipient via social media, as those characters are linked to all manners of communication. A recipient may be either an individual or entity.

Note that a website is considered a communication modality since a website constitutes presentation of content by a website owner to a communicant e.g. an end user of the system shown and described herein, this is the case even if/when the communicant cannot communicate with the website owner via the website.

FIG. 2 illustrates embedded e-mail on the device, wherein the e-mail address is the phone number assigned to the device, all in accordance with an embodiment of the invention.

FIG. 3 illustrates an embedded webpage or preset data, all in accordance with an embodiment of the invention.

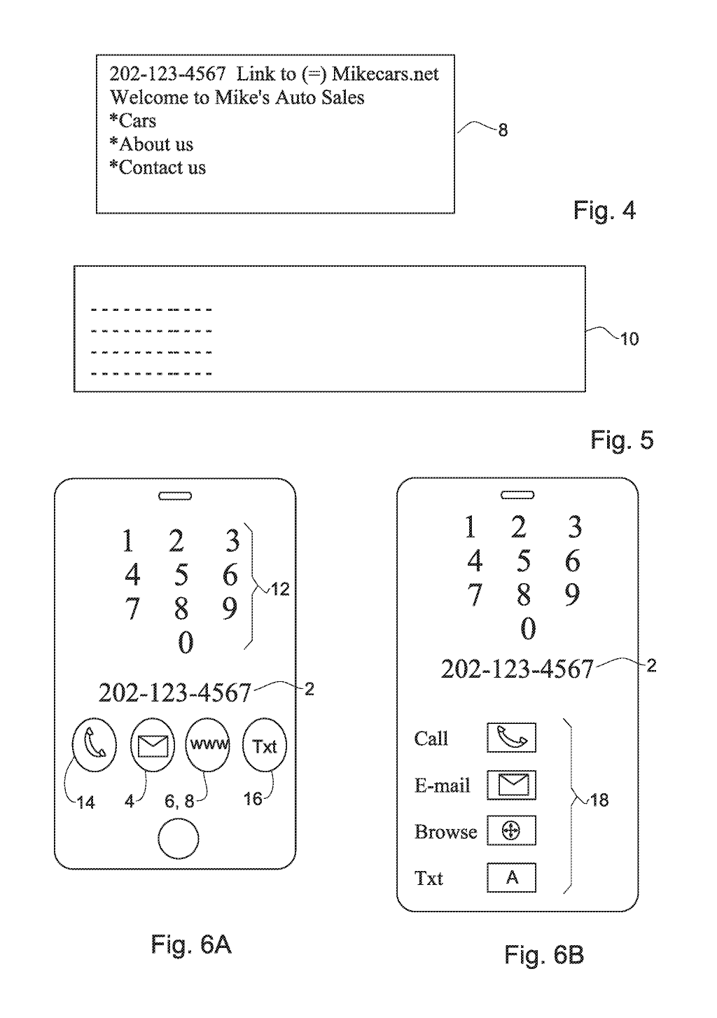

FIG. 4 illustrates a Link to an existing webpage or desired address (Facebook, Twitter . . . ), all in accordance with an embodiment of the invention.

FIG. 5 illustrates a Link to an existing e-mail address, e.g. 202-123-4567 may Link to (=) Mike123@yahoo.com, all in accordance with an embodiment of the invention.

The character (2) in FIGS. 1-6B typically comprises a numeric telephone number associated with a recipient contact. The name of the recipient associated with those characters can be an electronic device if that recipient is associated in the device with those characters. A user may store and save recipient characters on the electronic device or may use those characters to enable the software to communicate with a recipient that may not be known.

From the home screen, a user can choose from different channels of communication with the recipient, e.g. as seen in FIGS. 6A-6B. Once the choice is made, the user executes the desired mode (“modality”) of communication by pressing the icon (collectively, 18) on the screen affiliated therewith. The user can choose to call the contact by pressing the phone icon (14). The user can choose to email the contact by pressing the email icon (4). The user may send a text to the contact by selecting the txt icon (16). The user can access the contact's homepage on the Internet by selecting the www icon (6, 8). The user can access the contact's social media account by selecting the social media icon e.g. SM (27).

Once the selection is made, the software automatically transmits the desired data over a communications network. If the phone icon (14) is selected, an audio call is transmitted to the contact's desired telephone. If the email icon (4) is selected, a screen with a complete alphanumeric keyboard (24) appears which allows the text of the email to be entered and subsequently transmitted to the contact. If the txt icon (16) is selected, a modified version of the same screen appears which allows a text message to be entered and subsequently transmitted to the contact. If the www icon (6, 8) is selected, the user is communicated to the contact's website homepage. If a social media (SM) icon (27) is selected, the user is communicated to the contact's social media server account. It is appreciated that any suitable icons may be employed in the context of the present invention, e.g. to identify respective virtual buttons or selectable areas to users of a cell app or other implementation which may or may not have a touch screen display.

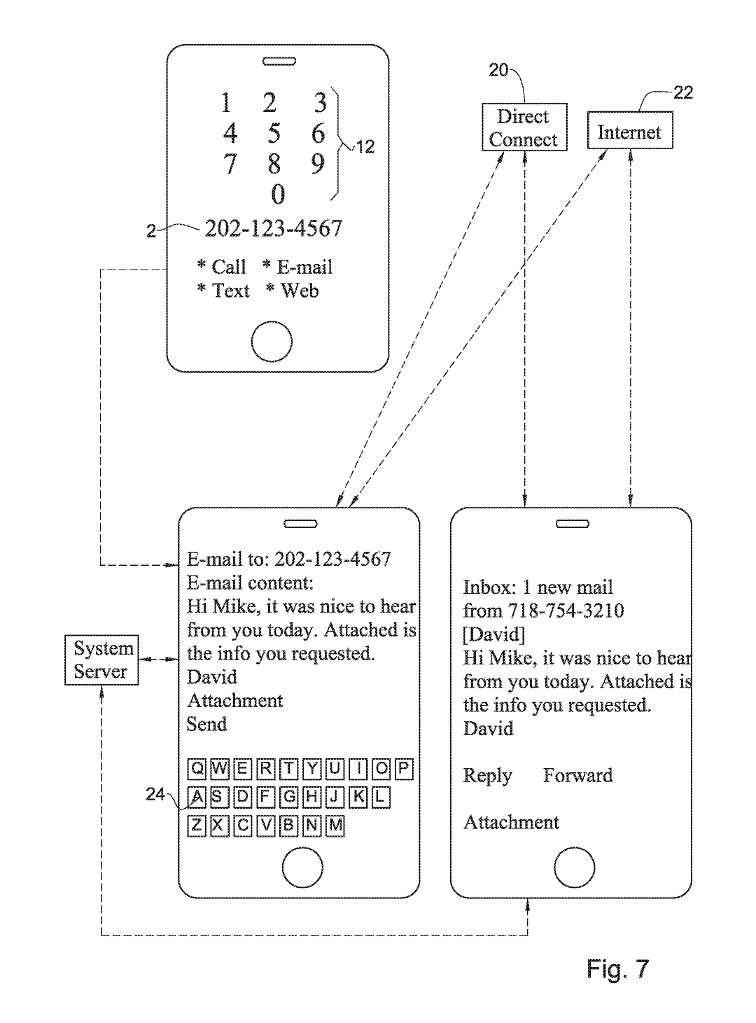

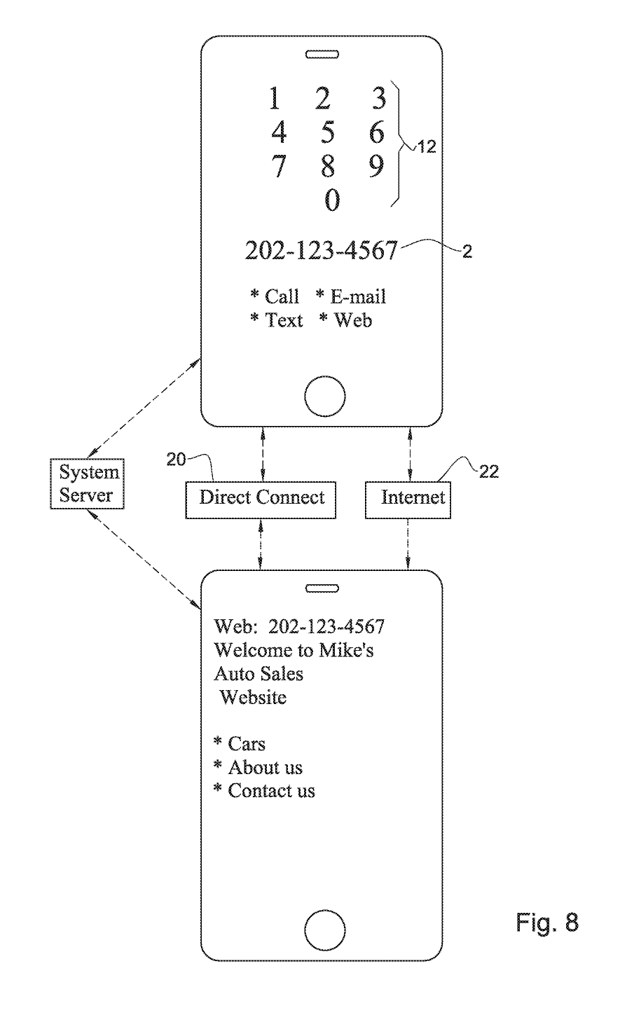

As seen in FIGS. 7 and 8, the communications and/or transmittals and transfers are all initiated, e.g. from inside the app or from the contact's home website screen, e.g. by touching the icon affiliated with the desired action. Responsively, the email or webpage may then be retrieved. The software facilitates the selected communications and/or transmittal and transfer over a communications property (20, 22) to the recipient. The communications property may include a cellular communications network, but may be any similar mobile communication.

A recipient may respond to a received message in the same manner as the one used to originally contact the recipient.

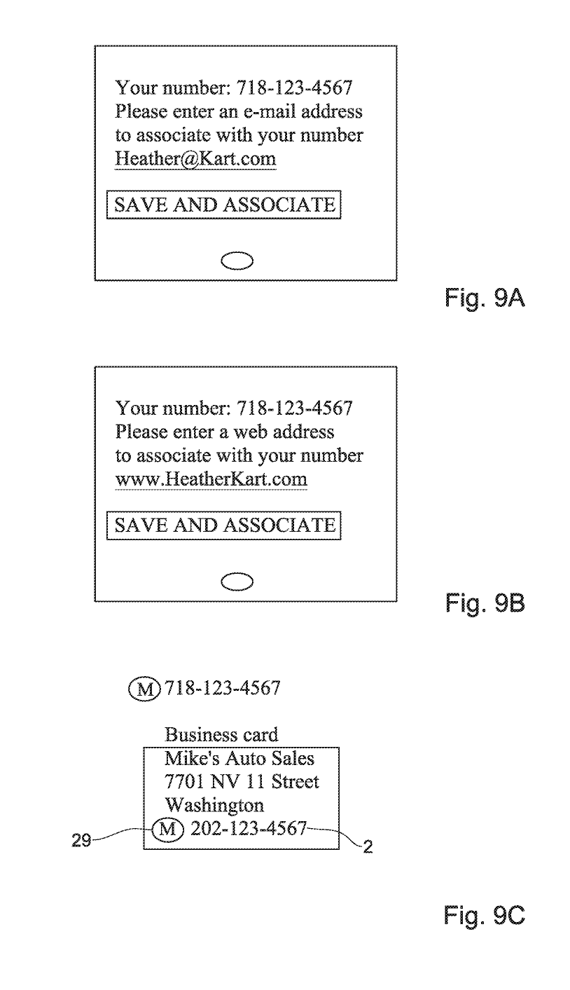

FIG. 9c depicts a specialized character (29) in front of a phone number (2) that indicates that the phone number is also associated with other information about that recipient. This specialized character (29) relates to apparatus to display that the phone number (2) is also associated with an email, web address, social media account or the like.

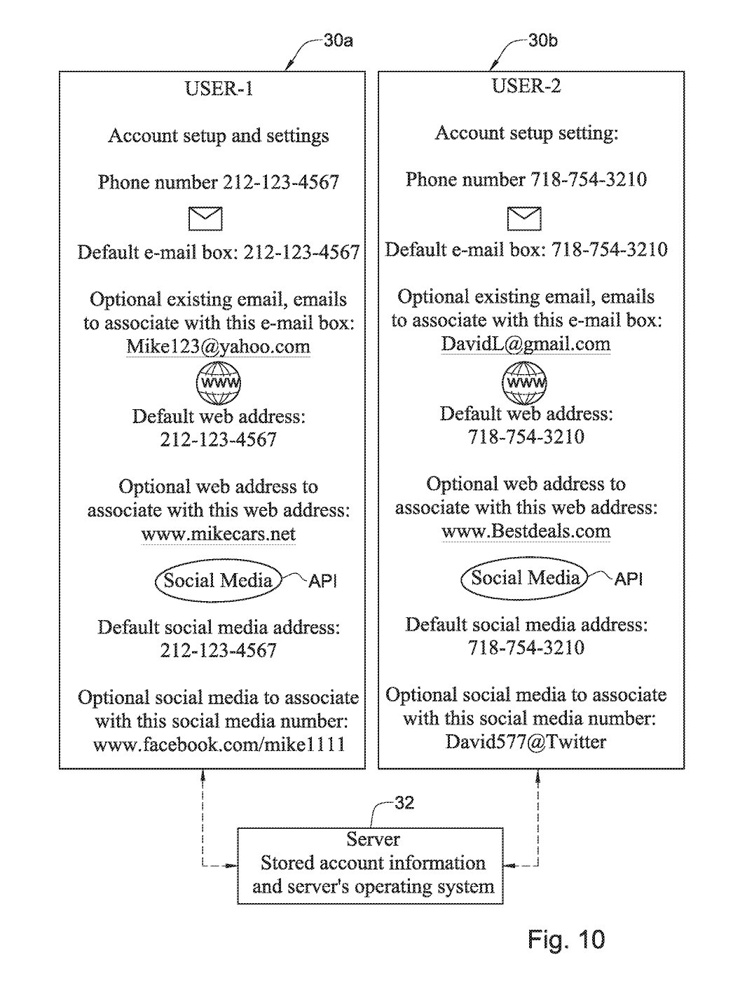

FIG. 10 depicts the information (30a, 30b) that may be stored on a server (32). Information (30a) relates to one user and information (30b) relates to a second user. Thus, when a user desires to contact a person and only has partial contact information, a character associated with the recipient may be entered and the server (32) may access all known associated information regarding that recipient.

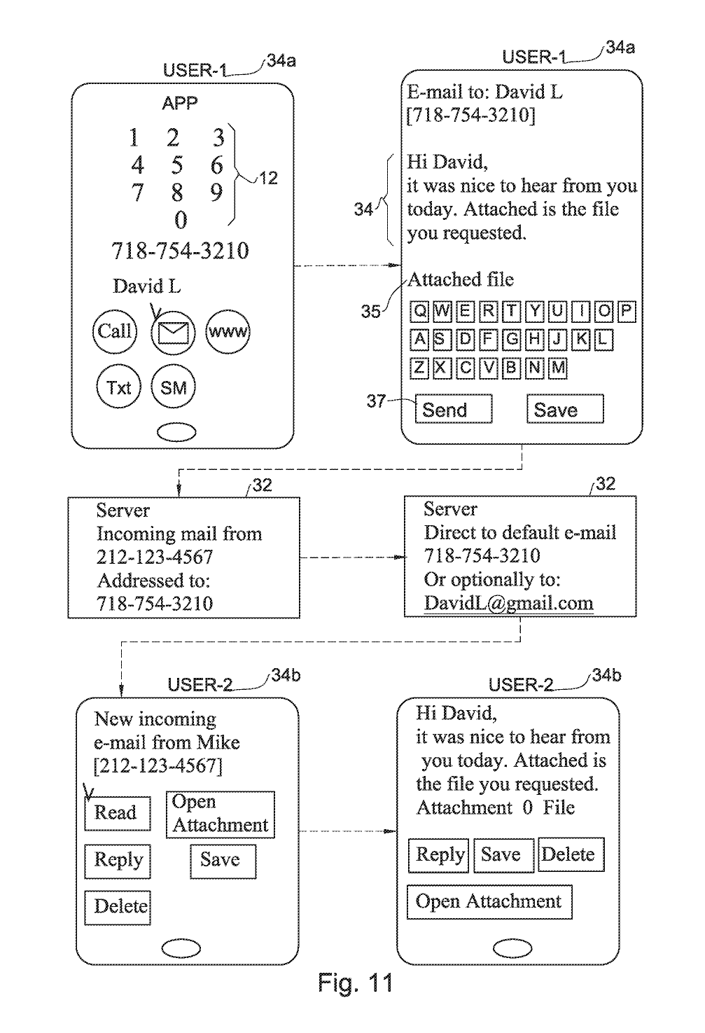

FIG. 11 depicts the flow of one user (34a) contacting a second user (34b). User 1 (34a) uses his/her electronic device (1) and enters in characters associated with user 2 (34b). In this case, the characters are a phone number (2). User 1 (34a) then enters an email message (36) for User 2 (34b) and attaches a file (35). Once user 1 (34a) pushes the send button (37), the server (32) is contacted and associates the phone number (12) to User 2's (34b) email address. User 1 (34a) may not know User 2's (34b) email address, but the server is able to associate that phone number (12) to a known, stored email address on the server (32). The message (36) and attachment (35) are then delivered to User 2 (34b). User 2 (34b) can then respond to User 1 (34a) in the same manner, whether or not User 1's (34a) contact information is known.

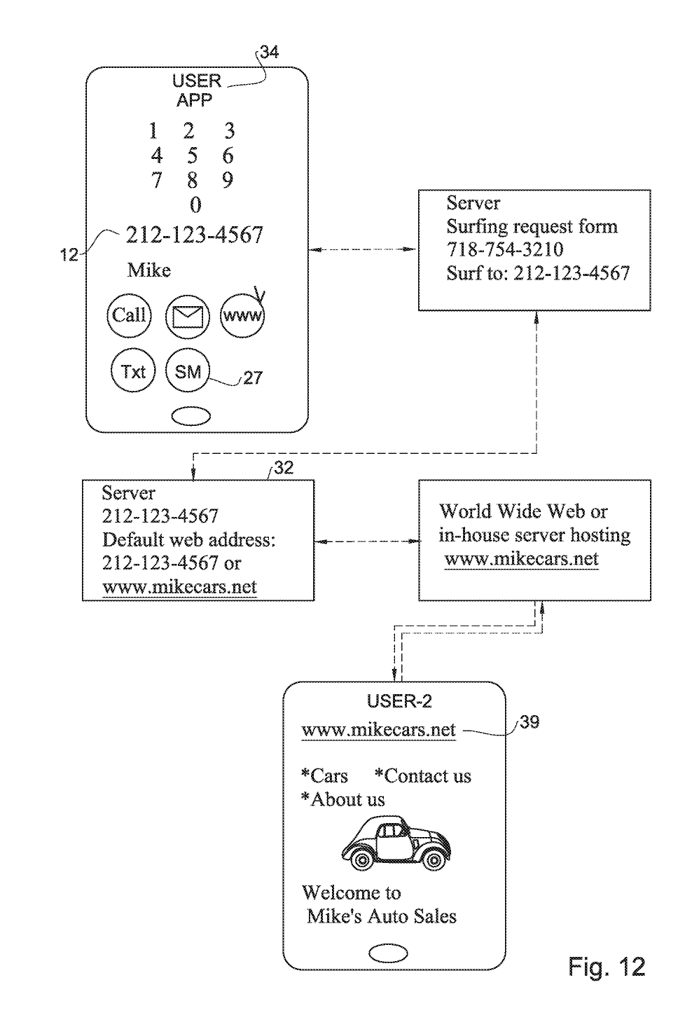

FIG. 12 depicts a flow chart of a user 34 utilizing a known phone number (12) and contacting an unknown web address (39) through the entered phone number (12). The phone number (12) is entered and then processed by the server (32) to direct a user (34) to a web address 39 associated with that phone number (12).

The term “mobile (communication) device” as used herein is intended to include but not be limited to any of the following: mobile telephone, smart phone, playstation, iPad, TV, remote desktop computer, game console, tablet, mobile e.g. laptop or other computer terminal, embedded remote unit.

A system and method configured to associate in memory, a user's contact information (destination) within plural communication modalities, which may, according to certain embodiments, be anchored by a user's phone number or other pre-selected “anchor” user contact data element, are now described. Certain embodiments are operative to facilitate electronic communication between persons each having plural communication modalities.

According to certain embodiments, an application server or “server” is provided which communicates with system applications or “apps” or “cellular applications” installed on a multiplicity of user communication devices such as smartphones, either for all users who wish to send via the server, or for all users who wish to receive via the server, or both. Alternatively, users may use the system via a website rather than via an app.

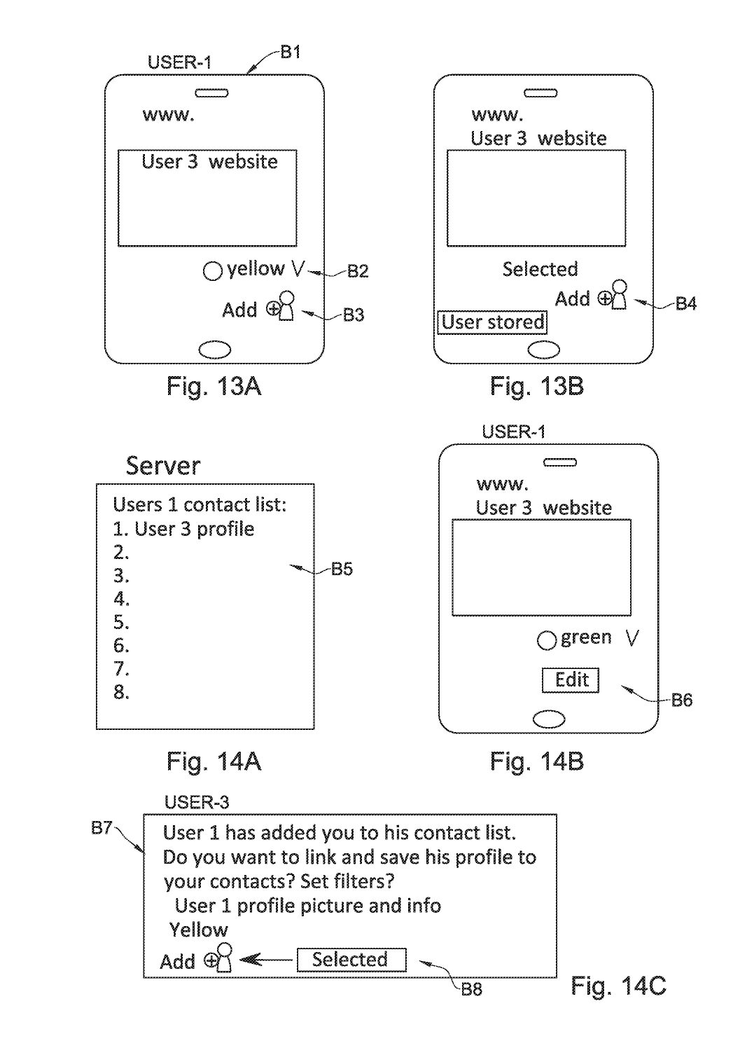

Certain embodiments are now described with reference to FIGS. 13a-32.

Reference is now made to FIG. 23 which is a method for cross cellphone-email communication according to certain embodiments. The method of FIG. 23 may include some or all of the following operations, suitably ordered e.g. as shown:

The method of FIG. 23 typically includes set-up operations 1010-1040 and an operational stage which may include operations 1050 onward.

The method of FIG. 23 may include some or all of the following operations, suitably ordered e.g. as shown:

Operation 1010: provide server and associated Internet domain (say: embodimentdomain.com) and memory tables e.g. end user table

Operation 1020: define “wildcard” e.g. catch-all or catch-error email address for embodimentdomain.com, such as wildcard@ embodimentdomain.com

Operation 1030: register a population of receiving (rx) users including entering her/him in end-user table

Operation 1040: optional: register a population of sending (tx) users

Operation 1050: tx (who may also be a receiving user rx) wants to send email to an rx whose cell number is (say) 0123456789. tx sends email to 0123456789 @embodimentdomain.com

Operation 1060: tx's email is sent to wildcard@ embodimentdomain.com because 0123456789@embodimentdomain.com is a non-existent email account in embodimentdomain.com

Typically, catch all is enabled on the system server. Any suitable SMTP server which supports catch all may be employed for this embodiment.

Determination of a spam email address (or the IP that the spam is sent from) is typically governed by DNSBL (DNS black list) or a similar entity, that notifies and updates the email providers of blacklisted email. The list may be built from various sources which identify, say, a large number of emails sent from a single email address (single IP address); email providers may then block that email address.

Operation 1070: server parses all emails arriving at wildcard@ embodimentdomain.com: for each such email, server strips off @embodimentdomain.com from the email address to yield the cell number

Operation 1072: server then uses that cell number to access rx in the end user table and retrieve's rx's email address

Operation 1074: server routes e.g. forwards tx's email content to rx's email address; if tx's email address is deemed private, the forwarded email does not have tx's email address as sender. Instead, the sender may have an email address in which the prefix is a derivable function of tx's cellphone number, e.g. 555@embodimentdomain.com as sender, if tx's cellphone number, 555, is not private

Operation 1080: optionally, after server receives confirmation that the forwarding was successful (e.g. if no error code arrives within a predetermined time window, since conventional email protocols provide sender with an error code if an email fails to deliver), the server deletes the forwarded email, for confidentiality purposes and/or to save storage space

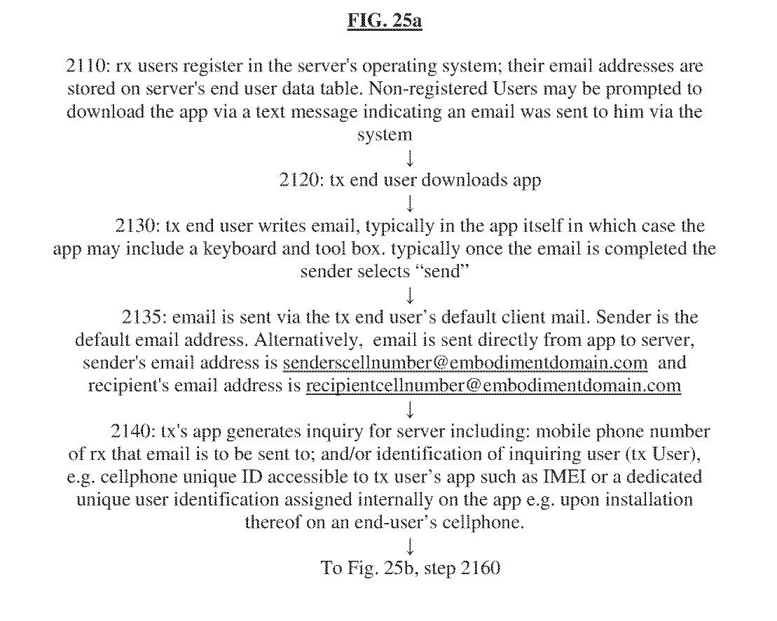

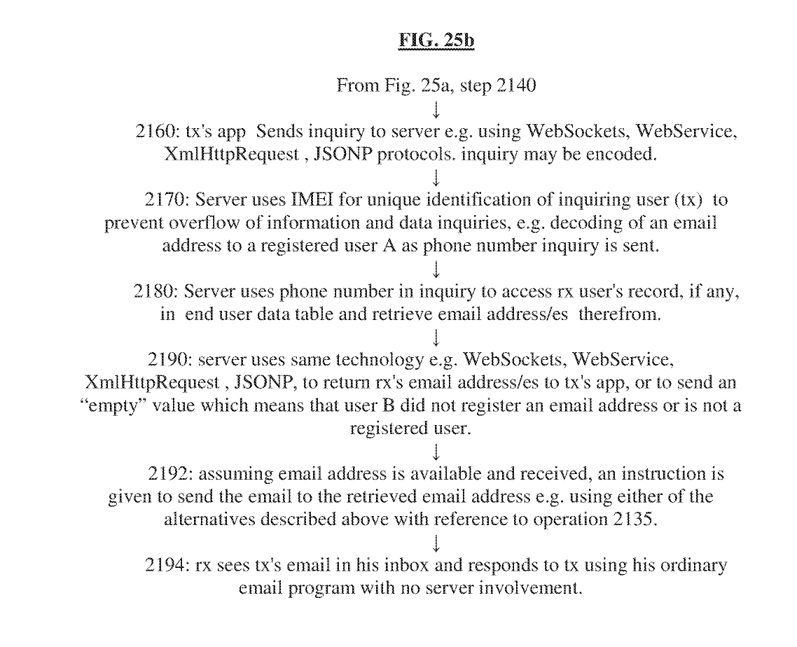

Operation 1090: rx responds to tx e.g. as described below with reference to operation 2135 in FIGS. 25a-25b.

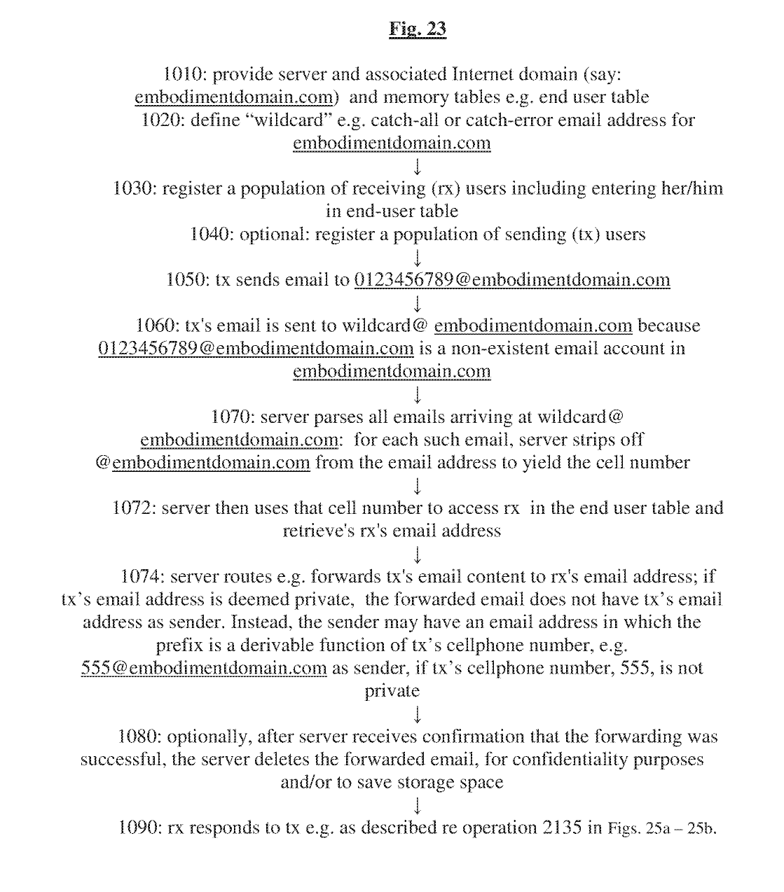

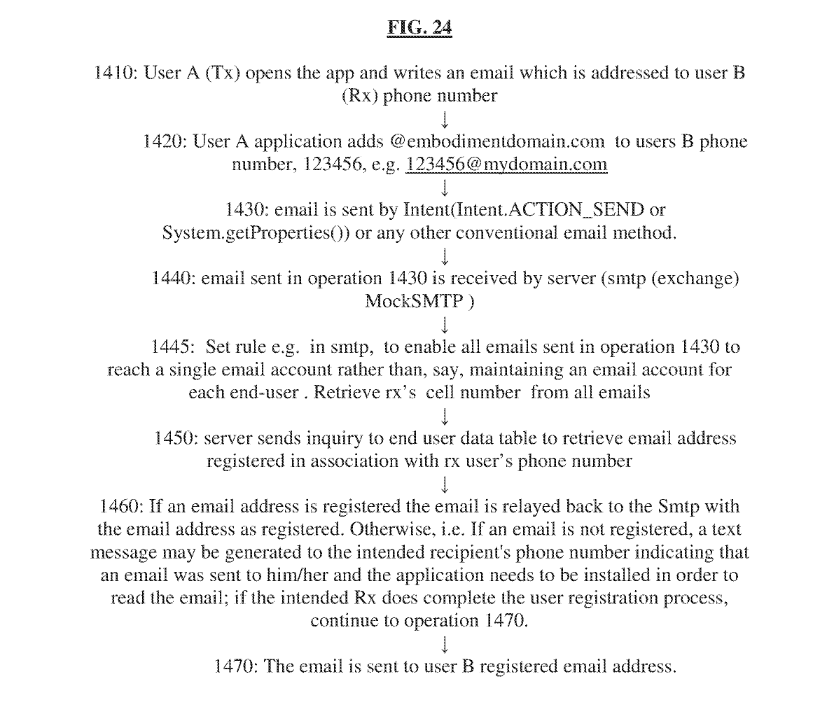

Alternatively, the operational stage may include some or all of the operations of FIG. 24, suitably ordered e.g. as follows:

Operation 1410: User A (Tx) opens the app and writes an email which is addressed to user B (Rx) phone number

Operation 1420: User A application adds @embodimentdomain.com to users B phone number, 123456, e.g. as follows: 123456@mydomain.com

Operation 1430: email is sent by Intent(Intent.ACTION_SEND or System.getProperties( )) or any other conventional email method.

Operation 1440: email sent in operation 1430 is received by server (smtp (exchange) MockSMTP)

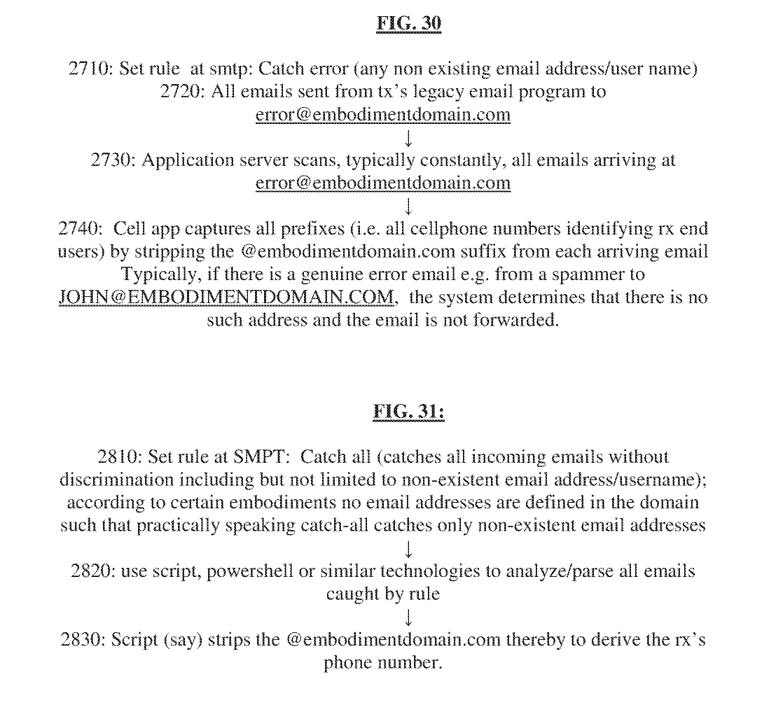

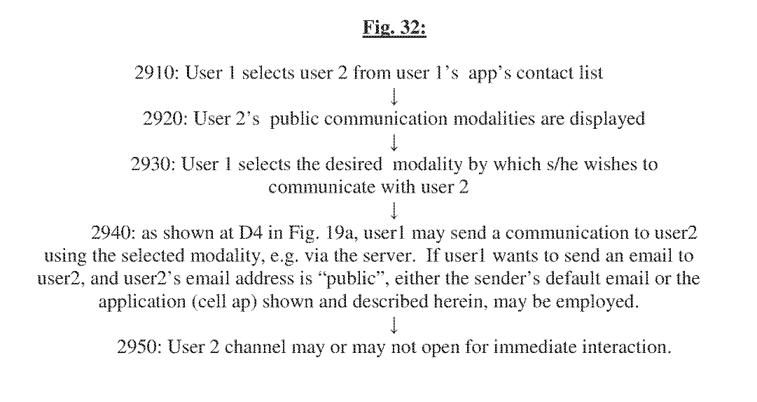

Operation 1445: Set rule e.g. in smtp, to enable all emails sent in operation 1430 to reach a single email account rather than, say, maintaining an email account for each end-user. Retrieve rx's cell number from all emails—e.g. as described below with reference to FIG. 30 or FIG. 31.

Operation 1450: server sends inquiry to end user data table to retrieve email address registered in association with rx user's phone number

Operation 1460: If an email address is registered the email is relayed back to the Smtp with the email address as registered. Otherwise, i.e. If an email is not registered, a text message may be generated to the intended recipient's phone number indicating that an email was sent to him/her and the application needs to be installed in order to read the email; if the intended Rx does complete the user registration process, continue to operation 2470.

Operation 1470: The email is sent to user B registered email address.

Reference is now made to FIGS. 25a-25b which, taken together, illustrate a method for cross cellphone-email communication according to other embodiments. The method of FIGS. 25a-25b may include some or all of the following operations, suitably ordered e.g. as follows:

Operation 2110: rx users register in the server's operating system; their email addresses are stored on server's end user data table. Non-registered Users may be prompted to download the app via a text message indicating an email was sent to him via the system

Operation 2120: tx end user downloads app

Operation 2130: tx end user writes email, typically in the app itself in which case the app may include a keyboard and tool box, typically once the email is completed the sender selects “send”,

Operation 2135: email is sent via the tx end user's default client mail. Sender is the default email address e.g. @gmail, @yahoo.com etc. email appears in tx's default sent folder. Alternatively, email is sent directly from app to server, sender's email address is senderscellnumber@embodimentdomain.com and recipient's email address is recipientcellnumber@embodimentdomain.com

Operation 2140: tx's app generates inquiry for server including:

mobile phone number of rx that email is to be sent to; and/or

identification of inquiring user (tx User), e.g. cellphone unique ID accessible to tx user's app such as IMEI or a dedicated unique user identification assigned internally on the app e.g. upon installation thereof on an end-user's cellphone.

The IMEI need not be provided e.g. if both users (tx, rx) are already registered. In this case the server may assign an internal user identification number for each user as well as a correspondence number for that specific exchange between 2 specific users at a specific time, and in this case the phone number may be “an iconic layer” e.g. what the app users visually see, for example email to phone #05811112222, whereas internally, the system server may have already assigned to and tx a unique id other than the imei number, since the imei is typically for the security level. Given to unique system ID's, one ID may send an email to another ID; and similarly, mutatis mutandis, for a web surfing request and a social networks request.

Operation 2160: tx's app Sends inquiry to server e.g. using WebSockets, WebService, XmlHttpRequest, JSONP protocols. inquiry may be encoded.

Operation 2170: Server uses IMEI for unique identification of inquiring user (tx) to prevent overflow of information and data inquiries, e.g. decoding of an email address to a registered user A as phone number inquiry is sent.

According to certain embodiments, tx—User A—registers with the app, and users' A phone number is registered in the server's user table in association with user A's IMEI device number. When an email is sent by user A, the server is configured to verify that the email is sent from a device that has the IMEI number stored in the user table for user A; typically user A's record is accessed using user A's phone number. The email is then sent only if both the cell and IMEI numbers match. If a user changes a device, the user typically is able, using her or his app, to verify sh/e is the actual phone number owner upon which the new IMEI number is saved in his record in the server's user table, and that verification may for example include receiving a code number texted to the user's phone and entering same.

Operation 2180: Server uses phone number in inquiry to access rx user's record, if any, in end user data table and retrieve email address/es therefrom.

Operation 2190: server uses same technology e.g. WebSockets, WebService, XmlHttpRequest, JSONP, to return rx's email address/es to tx's app, or to send an “empty” value which means that user B did not register an email address or is not a registered user.

Operation 2192: assuming email address is available and received, an instruction is given to send the email to the retrieved email address e.g. using either of the alternatives described above with reference to operation 2135.

Operation 2194: rx sees tx's email in his inbox and responds to tx using his ordinary email program with no server involvement.

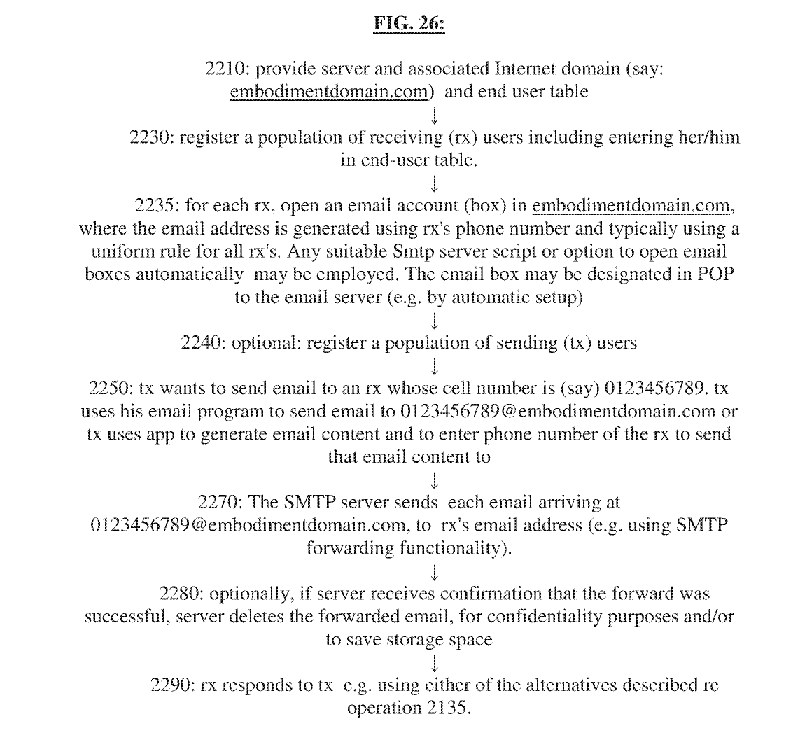

Reference is now made to FIG. 26 which is still another method for cross cellphone-email communication according to certain embodiments. The method of FIG. 26 may include some or all of the following operations, suitably ordered e.g. as shown:

Operation 2210: provide server and associated Internet domain (say: embodimentdomain.com) and memory tables e.g. end user table

Operation 2230: register a population of receiving (rx) users including entering her/him in end-user table.

Typically, end users install the application (cell app e.g.) shown and described herein and enter their entire contact information e.g. some or all of email, website, social media link and so forth. The application then relays the contact information to the operating system on the system server. The operating system typically creates a unique user identification for the new user, stores its IEMI number, phone number including any prefixes and the indented registered information (email, website, social) in its respective memory tables.

Operation 2235: for each rx, open an email account (box) in embodimentdomain.com, where the email address is generated using rx's phone number and typically using one uniform rule for all rx's. For example, an rx whose cell number is 0123456789 may be assigned the following email address: 0123456789 @embodimentdomain.com.

Any suitable Smtp server script or option to open email boxes automatically may be employed. The email box (e.g. name, phone number and domain) may be designated in POP to the email server (e.g. by automatic setup).

The program application may include email to client. The application may have all the email properties, such as send receive, read, attach but may not host the actual (content of) the email.

An additional option is specifying reception of the email in the default email program. According to this alternative, the properties described above need not be provided; instead the end user's default email program is opened thereby to enable the end user to simply send her or his email using her or his own default email program.

Optionally, no email address is created. Instead, the domain is automatically added and a table of user registration information is provided e.g. as described above. Typically, when an email is “addressed to” a particular cell number such as Ser. No. 05/299,999, the application on the mobile device adds (concatenates) the name of the domain associated with the system server, to the Number, for example: 05299999@mydomain.com. Email may then be sent by the application (cell app e.g.) to the domain server (e.g. the operating system server). The domain server may then employ catch all or any suitable alternative technique, described herein or known in the art, to capture the cellphone number. Once the cellphone number is known, the system checks the memory tables of the cellphone number (e.g. the email). If found, the email is addressed accordingly. Otherwise, e.g. if not found, a text message is sent to the phone number indicating that an email was sent to that cell number.

The phone owner may install the app or may reply by email to indicate where to send the email. If the app is installed, the information may be received in the email inbox of that user. Otherwise, e.g. if the app is not installed, the replied email may be captured, and the original email may be forwarded to the replied email (from the text message).

Typically although not necessarily, the email account created for each RX is permanent and both stays on the SMTP and is saved on the user table at the server.

Operation 2240: optional: register a population of sending (tx) users

Operation 2250: tx (who may also be a receiving user rx) wants to send email to an rx whose cell number is (say) 0123456789. tx uses his email program to send email to 0123456789@embodimentdomain.com or tx uses app to generate email content and to enter phone number of the rx to send that email content to

Operation2270: The SMTP server sends each email arriving at 0123456789@embodimentdomain.com, to rx's email address (e.g. using SMTP forwarding functionality).

Operation 2280: optionally, if server receives confirmation that the forward was successful (e.g. if no error code arrives within a predetermined time window, since conventional email protocols provide sender with an error code if an email fails to deliver), server deletes the forwarded email, for confidentiality purposes and/or to save storage space

Operation 2290: rx responds to tx e.g. using either of the alternatives described above with reference to operation 2135.

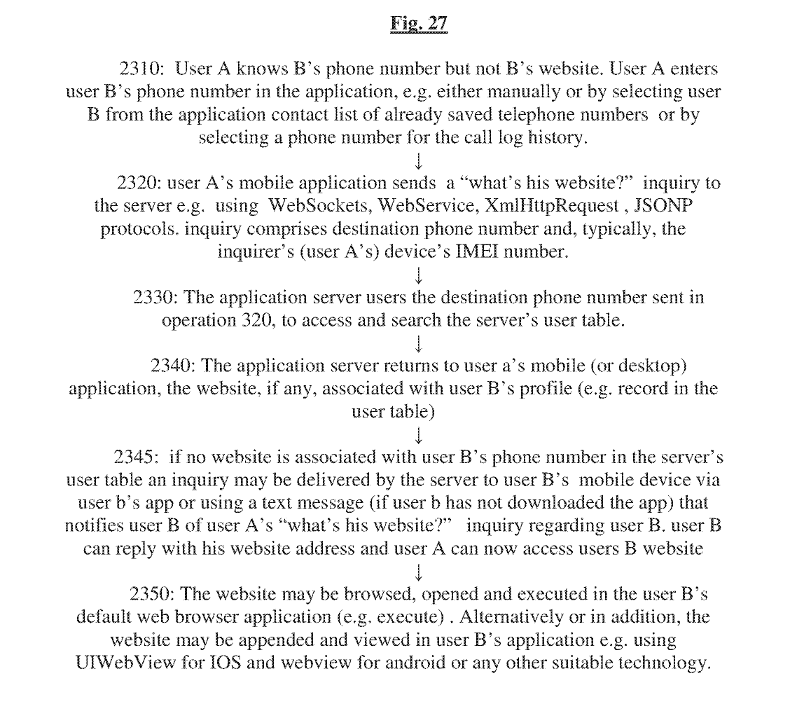

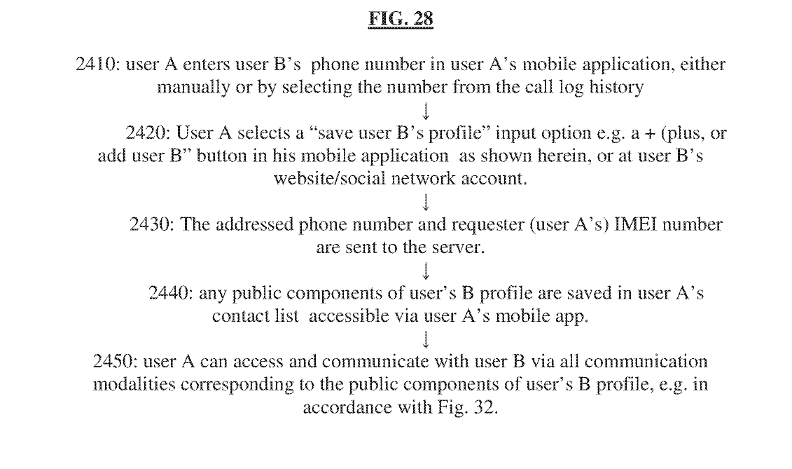

Reference is now made to FIG. 27 which is a method for cross cellphone-web communication according to certain embodiments. The method of FIG. 27 may include some or all of the following operations, suitably ordered e.g. as shown:

Operation2310: User A knows B's phone number (e.g. user A may currently be conversing with user B by phone) but not B's website. User A enters user B's phone number in the application, e.g. either manually or by selecting user B from the application contact list of already saved telephone numbers or by selecting a phone number for the call log history.

Operation 2320: user A's mobile application sends a “what's his website?” inquiry to the server (aka application server) e.g. using WebSockets, WebService, XmlHttpRequest, JSONP protocols. inquiry comprises destination phone number and, typically, the inquirer's (user A's) device's IMEI number.

Operation 2330: The application server users the destination phone number sent in operation 320, to access and search the server's user table.

Operation 2340: The application server returns to user a's mobile (or desktop) application, the website, if any, associated with user B's profile (record in the user table)

Operation 2345: if no website is associated with user B's phone number in the server's user table an inquiry may be delivered by the server to user B's mobile device via user b's app or using a text message (if user b has not downloaded the app) that notifies user B of user A's “what's his website?” inquiry regarding user B. user B can reply with his website address and user A can now access users B website e.g. as described below.

For example, if user B is a registered user that has not (yet) registered his website (and saved the website particulars in the server's user table data) the message regarding A's inquiry may be delivered from the server to the app on user B's communication device. If user B decides to provide information regarding her or his site s/he enters this information in the app for subsequent sharing with user A, or for multi sharing e.g. the configuration may selectably be that from now on the site can be viewed by all system users. Another option is that if user B is not a registered user (does not use the app) s/he nonetheless is given the option to reply with text indicating her or his website address. User A's app may then capture the replied text (containing B's website address) and may then open the site in user A's default browser or in the app's web view option. According to certain embodiments, the website address as captured is relayed by user A's app to the operating server to store user B's website in user A's contact table, for future surfing by A. User A may also write user B's name or any description for that contact, name/pic; all of this information may be saved under user A's contacts.

Operation 2350: The website may be browsed, opened and executed in the user B's default web browser application (e.g. execute). Alternatively or in addition, the website may be appended and viewed in user B's application e.g. using UIWebView for IOS and webview for android or any other suitable technology.

FIG. 28 is a simplified flowchart illustration of a method by which any user, A, can save and subsequently communicate with any public components of user's B profile (aka user B's record in the server's end user table), such as user B's email address, website, social network account/s, phone number). The method of FIG. 28 may include some or all of the following operations, suitably ordered e.g. as shown:

Operation 2410: user A enters user B's phone number in user A's mobile application, either manually or by selecting the number from the call log history.

Operation 2420: User A selects a “save user B's profile” input option e.g. a +(plus, or add user B” button in his mobile application as shown herein, or at user B's website/social network account.

If user B is also a registered user, he may have previously provided his mail, web, social Network account. It is appreciated that the first point of contact need not be a phone conversation between user A to B. Instead, for example, user A may surf and encounter user B's website. User A may then seek to “expand” her or his connection capabilities with user B. The system server knows that the website in question belongs to user B (e.g. associated or by default of user's B phone number), When user A selects ADD USER the system server may create a new contact for user B in user A's table and user A may now be able to communicate/interact with user B on all platforms. The first initiating contact may also be a text message. More generally, any sort of first contact or interaction between a domain of one user to another user may allow links with other contact particulars e.g. by creating a new contact profile.

Operation2430: The addressed phone number and requester (user A's) IMEI number are sent to the server.

Operation 2440: any public components of user's B profile are saved in user A's contact list accessible via user A's mobile app. This may be an internal contact list separate from a legacy contact list on the end user's phone.

However, the internal contact list typically has permission for full access to the legacy contact list. The internal contact list typically includes additional “layers” that represent modalities such as email, web, social network account, which typically correspond to the system server tables.

Operation 2450: user A can access and communicate with user B via all communication modalities corresponding to the public components of user's B profile, e.g. in accordance with FIG. 32.

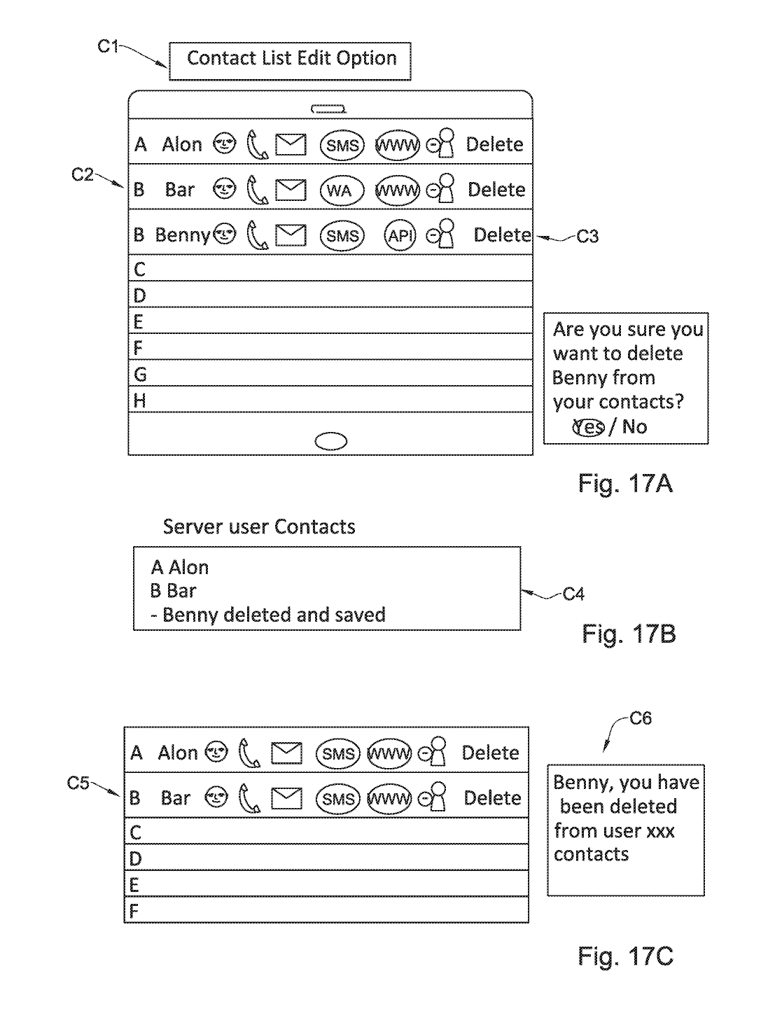

It is appreciated that once contacts are stored in the contact list, they can also be edited using any suitable logic, interface and technology e.g. as shown in FIGS. 17a-17c, of which FIGS. 17a and 17c include simplified screenshot illustrations of a cellphone in which the app described herein is installed and operative, and FIG. 17b illustrates deletion of an example contact, Benny, from the server's viewpoint; typically after the relevant user/s delete, the change is then stored on the server.

For example, User A may select her or his contact list (C1 in FIG. 17a), responsively to which the user's app typically lists all contacts alphabetically and displays a list of all contacts with their picture profile (C2 in FIG. 17a). User A then selects and (say) deletes the profile of user B (c3 in FIG. 17a). The server deletes user B from the user A's contact list (c4 in FIG. 17b); user B is then no longer displayed in the contact list (C5 in FIG. 17c). User B may get a notification from the system that he was deleted from user A's contact list (e.g. screen message within the app or text message—C6 in FIG. 17c). Thereafter, deleted user B is no longer displayed at the user A's contact list.

The user may be asked, e.g. via screen message within the app or text message, to confirm deletion and may respond e.g. by pressing a “delete” button, upon which his response is relayed back to the server, or by texting back (say) 1 to confirm or 0 otherwise.

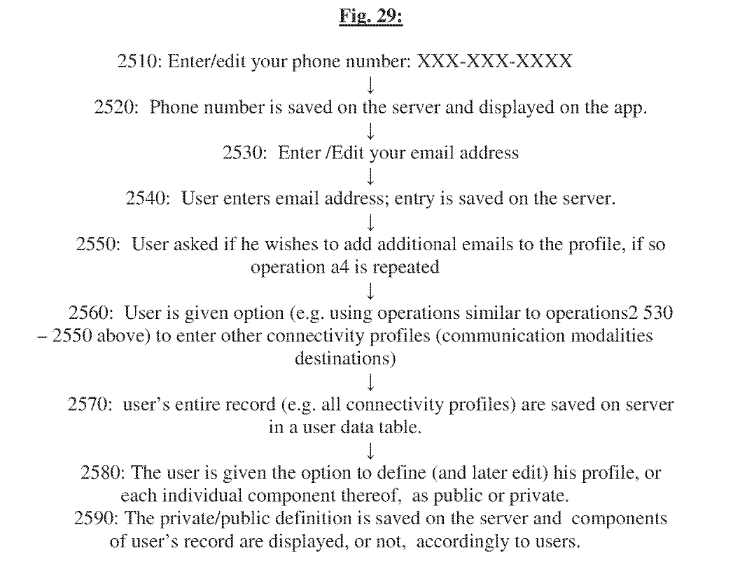

FIG. 29 is a simplified flowchart illustration of a method for using a cellphone app in accordance with certain embodiments, to become a registered user able to receive communications via the system shown and described herein, including defining certain communication modality destinations as private, and others as public.

The method of FIG. 29 may include some or all of the following operations, suitably ordered e.g. as shown:

Operation 2510: Enter/edit your phone number: XXX-XXX-XXXX

Operation 2520: Phone number is saved on the server and displayed on the app.

Operation 2530: Enter/Edit your email address

Operation 2540: User enters email address, entry is saved on the server.

Operation 2550: User asked if he wishes to add additional emails to the profile, if so operation a4 is repeated.

Operation 2560: User is given option (e.g. using operations similar to operations 530-550 above) to enter other connectivity profiles (communication modalities destinations) e.g. website, social media accounts

Operation 2570: user's entire record (all connectivity profiles) are saved on server in a user data table.

Operation 2580: The user is given the option to define (and later edit) his profile, or each individual component thereof, as public or private.

Operation 2590: The private/public definition is saved on the server and components of user's record are displayed, or not, accordingly to users.

Referring again to FIG. 3 and/or FIG. 13a onward, a “reciprocal” method according to which unlinked users—user1 and user3—not stored at each other's contacts list, may respectively build their contact list, is now described:

User 3 enters user 1's platform.

When a user 3 comes across a member that is not stored, user3 can see (say) a yellow light or half V checked that indicating the platform entered is open for interaction, yet user 3 has not added user 1 to his/her contact list. User 3 has the option to add user 1's profile to his (user 3's) contact list.

According to certain embodiments, once user 1 is added, user1 gets a notification that he—user1—was added to another user's profile (user3) and is asked if he wants to reciprocate by adding that user's profile to his contacts as well.

### EXAMPLE

Some or all of the following operations may be performed, suitably ordered e.g. as follows:

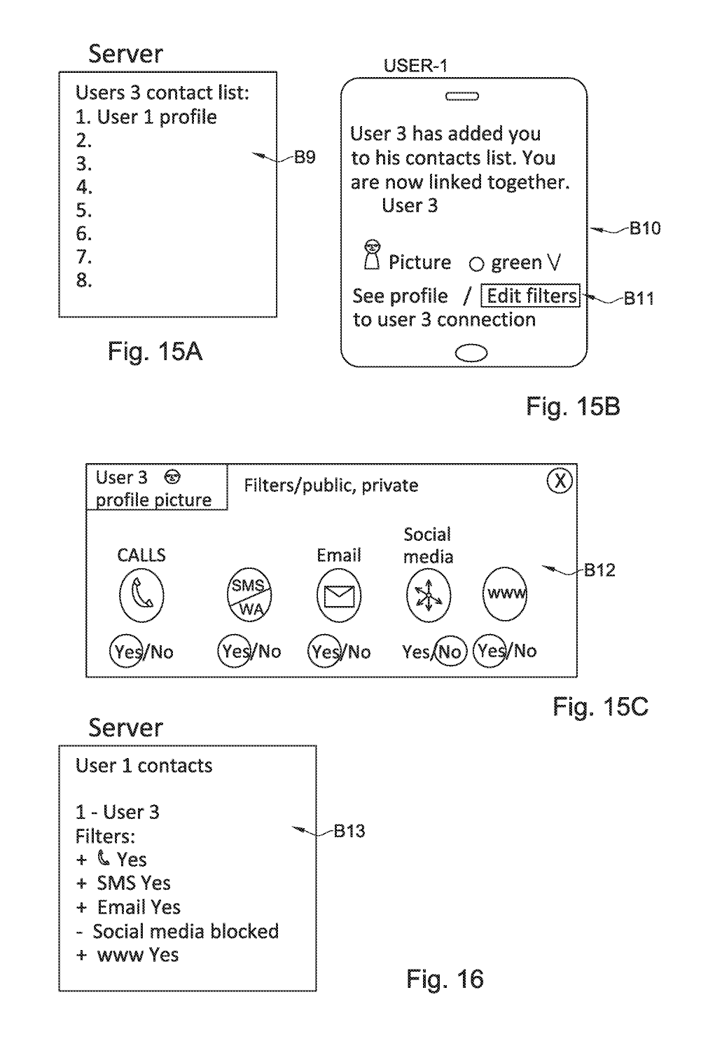

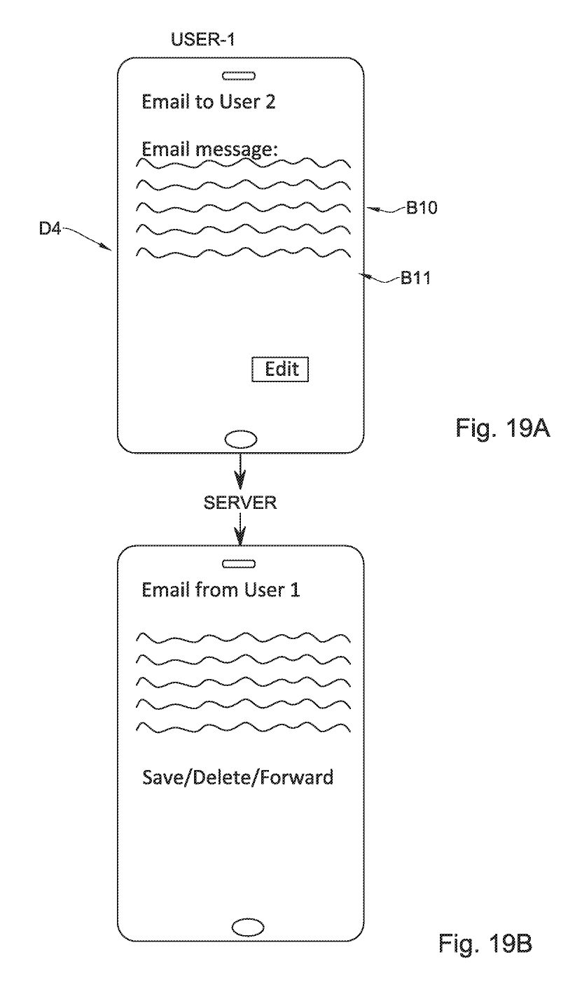

2601: User 1 enters user 3's platform, e.g. as shown at B1 in FIG. 13a, The platform may for example comprise a website, web-page, or social media page.
2602: User 1 gets indication (e.g. Yellow light or half V checked symbol) from the server/app that the platform entered is of a registered user, e.g. as shown at B2 in FIG. 13a.
2603: User 1 has the option to add user 3 to his contact list, e.g. as shown at B3 in FIG. 13a.
2604: User 1 Adds User 3 to his contact list, e.g. as shown at B4 in FIG. 13b.
2605: The server stores user 3 in user 1's contact list, e.g. as shown at B5 in FIG. 14a.
2606: User 1 sees user 3 with a green light or fully checked V symbol/picture across all of user 3's platforms, e.g. as shown at B6 at FIG. 14b.
2607: The system/app notifies user 3 that user 1 has added him to his contact list (display yellow light or half V checked/picture), user 3 can add user 1 to his contact list as well or may prefer not to, e.g. as shown at B7 in FIG. 14c.
2608: User 3 adds user 1 to his contact list if he so chooses, e.g. as shown at B8 in FIG. 14c.
2609: The server stores user 1 into user 3 contact list, e.g. as shown at B9 in FIG. 15a.
2610: User 1 gets a notification that user 3 has saved him to his contact list. Since user 3 is already stored at users 1 contact list the system may not suggest reciprocity to user 1, e.g. as shown at B10 in FIG. 15b, FIG. 19a.
2611: User 1 selects to set privacy filters pertaining to user 3, e.g. as shown at B11 in FIG. 15b,

In the example of FIG. 15c, the following communication modalities are permitted from user 3 to user 1: calls, sms/wa, email and surfing to user 1's website. Conversely, communication of user 1 with user 3 via social media is not permitted.

2612: User 1 edits filters pertaining to user 3, e.g. as shown at B12 in FIG. 15c.
2613: User 1 filter setting to user 3 is sent to the server and saved, e.g. as shown at B13 in FIG. 16. The above example is best understood with reference to FIGS. 13a-16 of which FIGS. 13a, 13b, 14b, 14c, 15b, and 15c include simplified screenshot illustrations of a cellphone in which the app described herein is installed and operative and FIGS. 14a, 15a, 16 include simplified pictorial illustrations of a user contact list as it is generated by the application server described herein. FIG. 16 illustrates the user table privacy settings once all filters have been set and saved on the server.

FIG. 30 is a simplified flowchart illustration of a method for performing operation 45 in FIG. 24 according to a first embodiment of the present invention.

The method of FIG. 30 may include some or all of the following operations, suitably ordered e.g. as shown:

Operation 2710: Set rule at smtp: Catch error (any non existing email address/user name)

Operation 2720: All emails sent from tx's legacy email program to error@embodimentdomain.com

Operation 2730: Application server scans, typically constantly, all emails arriving at error@embodimentdomain.com

Operation 2740: Cell app captures all prefixes (i.e. all cellphone numbers identifying rx end users) by stripping the @embodimentdomain.com suffix from each arriving email Typically, if there is a genuine error email e.g. from a spammer to JOHN@EMBODIMENTDOMAIN.COM, the system determines that there is no such address and the email is not forwarded.

FIG. 31 is a simplified flowchart illustration of a method for performing operation 45 in FIG. 24 according to a second embodiment of the present invention.

The method of FIG. 31 may include some or all of the following operations, suitably ordered e.g. as shown:

Operation2810: Set rule at SMPT: Catch all (catches all incoming emails without discrimination including but not limited to non-existent email address/username); according to certain embodiments no email addresses are defined in the domain such that practically speaking catch-all catches only non-existent email addresses

Operation 2820: use script, powershell or similar technologies to analyze/parse all emails caught by rule

Operation 2830: Script (say) strips the @embodimentdomain.com thereby to derive the rx's phone number.

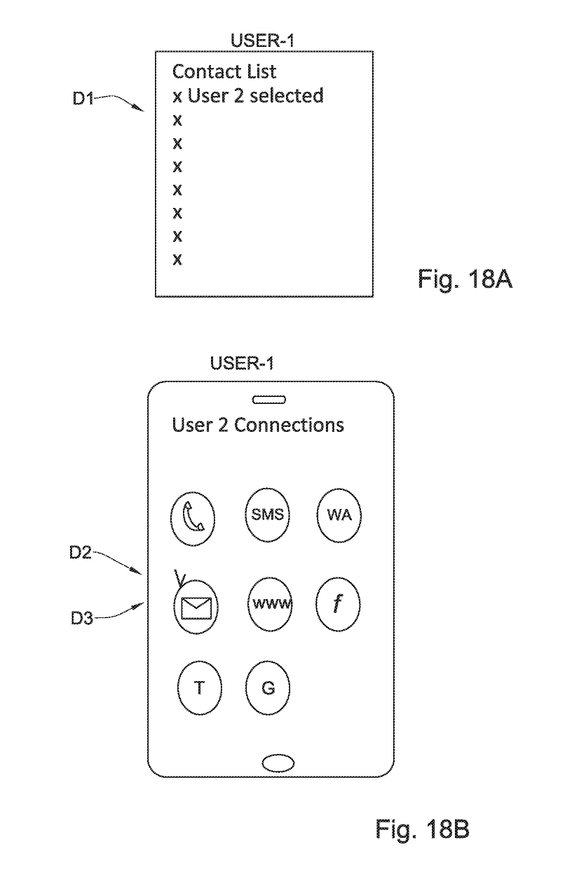

FIG. 32 is a simplified flowchart illustration of a method according to which a user A can access and communicate with user B via all communication modalities corresponding to the public components of user B's profile, e.g. as per FIG. 28, operation 440. The method of FIG. 32 is best understood with reference to FIGS. 18a-19a, of which FIGS. 18b, 19a, 19b include simplified screenshot illustrations of a cellphone in which the app described herein is installed and operative and FIG. 18a includes a simplified pictorial illustration of a user contact list as it is generated by the application server described herein.

The method of FIG. 32 may include some or all of the following operations, suitably ordered e.g. as shown:

Operation2910: User 1 selects user 2 from user 1's app's contact list (e.g. as shown at D1 in FIG. 18a).

Operation 2920: User 2's public communication modalities are displayed (e.g. as shown at D2 in FIG. 18b).

Operation 2930: User 1 selects the desired modality by which s/he wishes to communicate with user 2 (e.g. as shown at D3 in FIG. 18b; it is appreciated that the V symbol is used in the drawings to denote selection of an option by a user).

Operation 2940: as shown at D4 in FIG. 19a, user1 may send a communication to user2 using the selected modality, e.g. via the server. If user1 wants to send an email to user2, and user2's email address is “public”, either the sender's default email or the application (cell ap) shown and described herein, may be employed.

Operation 2950: User 2 channel may or may not open for immediate interaction. For example, user 2's website might not yet be linked to (e.g. registered within) the system server when user 1 requests access to user 2's website. In this case, a message is typically sent to user2, prompting her or him to associate her or his website to the system server e.g. by providing her or his website particulars for storage in the record, in the end user data repository or table, associated with user2.

It is appreciated that the end user data may be stored in data table/s accessible to the server and/or cellular apps in any suitable format. For example, the end user data may be stored in a single table having a field for all or any subset of the following end user data items:

User's serial number or other unique identifier in the system shown and described herein, user's name, cellphone, Main Email address, IMEI of user's device, legacy email program (e.g. outlook, gmail), country code (e.g. 972 for Israel), URL of user's picture e.g. as saved on the application server, current status e.g. away/in office & available/in-office and busy, and communication modality destinations such as but not limited to: secondary Email address, Additional phone number, Whatsapp account; Facebook account, Linkedin account, Twitter account, Google account. Skype account, Instagram account and so forth. Additional fields, e.g. one per communication modality destination, may be provided to store privacy setting/s (e.g. 0=private, 1=public) for each communication modality destination such as each telephone number, email address, and so forth. Additional fields may be provided to store the date/time at which each field was last updated.

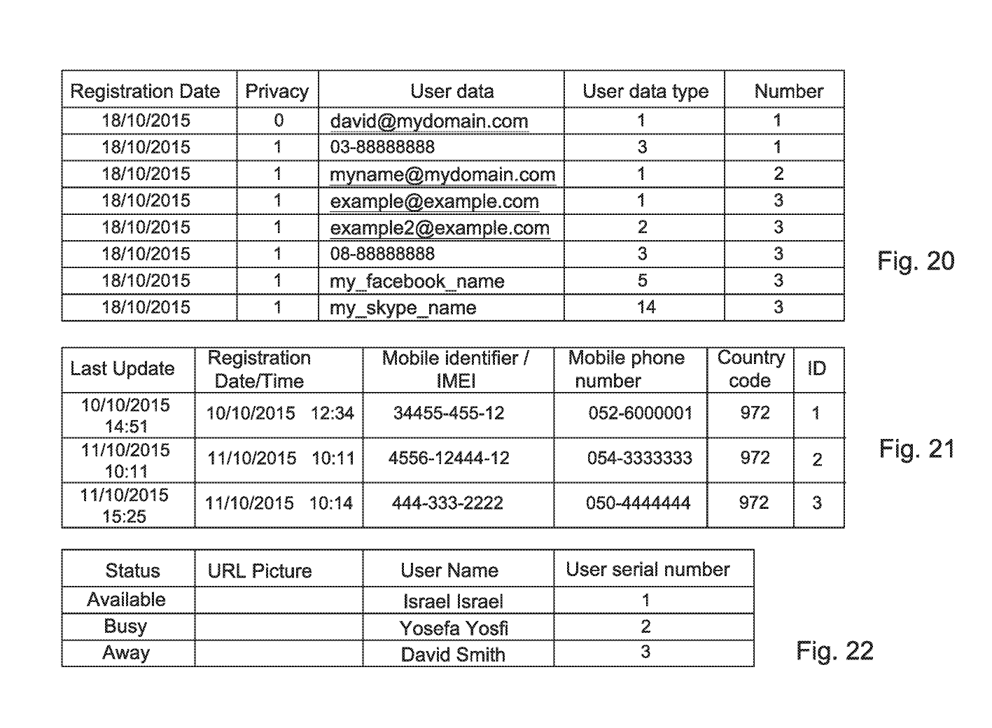

Alternatively, the end user data may be stored in more than one user data table e.g. the tables of FIGS. 20-22; references herein to a “table” of end user data used by the server are intended to include implementations in which a plurality of data tables, e.g. relational, may be provided e.g. as shown in FIGS. 20-22.

The “data type” column indicates the type of data in the data column, e.g. some or all of: 1=user's Main Email address, 2=user's secondary Email address, 3=user's Additional phone number, 4=user's Whatsapp account; 5=user's Facebook account, 6=user's Linkedin account, 7=user's Twitter account, 8=user's Google account, . . . 14=user's Skype account, and so forth.

According to certain embodiments, at least one “user preference” field is provided in the end user table/s allowing an individual end-user to select a preferred communication modality. This field can then be used as an input by logic in a suitably programmed processor at the server, which is thereby configured to ensure that content arriving for that individual user is provided to her or him via her or his preferred communication modality. For example, a particular user, A, may prefer to receive all possible content via SMS whereas another user, B, may prefer to receive all possible content via email. A third user may prefer to receive all possible content as Facebook messages. Another example is that institutional users, such as medical or banking institutions, may prefer facsimile transmission over all other communication modalities.

The above embodiments may employ any suitable technology such as but not limited to:

1: API (Application programming interface) typically providing full access to all incoming data, e.g. to all, and facilitates replies to another type of API.
2: API to web-service, allowing data to be captured from the API and relayed to other users via a Web-service.

It is appreciated that in the reverse direction, web-service data may be captured and relayed to other users who may have an application with API support.

If at least one “user preference” field is provided as above, according to certain embodiments default values may be provided therein. For example, the system may prompt each end user to indicate his age when registering, and may then assume a default preference of older users for emails, and of younger users for SMS. Alternatively or in addition, machine learning may be employed to develop default values; for example, if many users whose country code is 972 (Israel) are found to prefer What'sApp to other communication modalities, the system may assign a default preference for What'sApp to all users whose country code is 972, which the user can of course modify if s/he prefers modalities other than What'sApp.

It is appreciated that any suitable API may be provided to facilitate provision of the cross-modality functionality shown and described herein, e.g. between the system server (“server”) and one or more legacy systems providing communication via a particular modality.

If a user places a phone call, the number may be routed through a server and/or application software, in which the system recognizes both the originating number and destination number. The server and/or application software may send an automatic electronic inquiry to the destination number asking to share and permit other communication modes that the destination user may have with the originating user.

It is appreciated that certain embodiments are not limited to Simple Mail Transfer Protocol (SMTP), and that an Internet standard for electronic mail (email) transmission may instead be implemented, mutatis mutandis, using alternative protocols, such as but not limited to LMTP, AMTP or proprietary protocols.

It is appreciated that communication modalities need not be limited to email, cellphone, website/webpage and social media accounts, and that these are merely examples.

It is appreciated that according to certain embodiments, in order for users to interact with each other, they do not necessary have to be stored in each other's contacts list.

It is appreciated that the cellphone number need not be the “anchor” via which an end user's record is accessed. Instead, any particular e.g. alphanumeric string known to other users, such as the end user's name or email address, may be employed. According to certain embodiments, a first end user seeking to communicate with John (say) may know John's email address, and the system server facilitates communication between the first end user and John via a communication modality other than email, and a second end user seeking to communicate with John (say) may know John's cellphone, and the system server facilitates communication between the first end user and John via a communication modality other than cellphone.

According to other embodiments, end users seeking to communicate with John are each required to provide John's cellphone number or, more generally, all end users are required to provide a predetermined single communication modality destination (anchor) of John's.

The word “comprise” and its derivatives indicate the inclusion of not only the listed components, operations or features that it directly references, but also other components, operations or features not specifically listed, unless the contrary is expressly stated or the context requires otherwise.

It is appreciated that terminology such as “mandatory”, “required”. “need” and “must” refer to implementation choices made within the context of a particular implementation or application described herewithin for clarity and are not intended to be limiting since in an alternative implementation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware and/or firmware, if desired, using conventional techniques, and vice-versa. Each module or component may be centralized in a single location or distributed over several locations.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The system may, if desired, be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with, but external to, the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention, including operations, which are described in the context of separate embodiments may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA. Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

1. A multi-modality electronic communication method for communication via end-user selected communication modalities, the method comprising:
at a server,
the server including a processor having access to at least one memory table operative to store, for each individual end user from among a multiplicity of end users, a plurality of destinations via which the individual end user receives communications via a corresponding plurality of communication modalities;
receiving at least one communication from at least one Tx client processor serving a Tx end user, the communication including:
content which the Tx end user wishes to send to an Rx end user; and
an indication of a known destination of an Rx end user, when a first communication modality is employed;
extracting said known destination from said communication and retrieving from the table, a retrieved destination other than said known destination via which the Rx end user receives communications via a second communication modality other than the first communication modality; and
sending said content to the Rx end user via the second communication modality to the retrieved destination.

2. A method according to claim 1 wherein the first communication modality comprises cellphone communication and the known destination when the first communication modality is used, comprises the Rx end user's cellphone number.

3. A method according to claim 1 wherein the second communication modality comprises email, and the retrieved destination comprises the Rx end user's email address.

4. A method according to claim 1 wherein the at least one communication from at least one Tx client processor is received via at least one of the following channels: email, text messaging, url, API.

5. A method according to claim 4 wherein the server includes at least one email server configured for accepting emails within a domain

6. A method according to claim 5 wherein the Tx client processor sends a plurality of email messages to a plurality of email addresses all having said domain as a suffix and having prefixes respectively indicative of a corresponding plurality of known destinations of a corresponding plurality of Rx end users.

7. A method according to claim 6 characterized in that a plurality of email messages is routed to a single email account in the domain.

8. A method according to claim 1 wherein the memory table stores, for at least some destinations to be retrieved, an indication of whether said destinations are private and cannot be revealed to a registered Tx end user or public hence can be revealed to a registered Tx end user.

9. A method according to claim 8 wherein second communication modality comprises sending an email originated by a Tx user and intended for an Rx user, and wherein, for each private destination, said sending comprises setting the email's sender to be an email address whose suffix is a domain associated with the server and whose prefix is indicative of a destination of the Rx user which is known to the Tx user.

10. A method according to claim 8 wherein second communication modality comprises sending an email originated by a Tx user and intended for an Rx user, and wherein, for each public destination, said sending comprises using a legacy email program associated with the Tx client processor to send the email.

11. A method according to claim 8 wherein if the Rx user sends to the server, reply content intended for the Tx user, via the Rx user's client processor and the Tx user's email address is private, the server is configured to send a reply email, including said reply content, to said Tx user, including setting the reply email's sender to be an email address whose suffix is a domain associated with the server and whose prefix is indicative of a destination of the Tx user which is known to the Rx user.

12. A method according to claim 6 wherein all of said prefixes are generated from said known destinations using a single rule known to the server such that the known destinations can be derived from the prefixes by the server without pre-storing associations between prefixes and known destinations.

13. A method according to claim 7 wherein said single email account comprises a catch-all email account.

14. A method according to claim 7 wherein said single email account comprises a catch-error email account.

15. A method according to claim 1 and also comprising sending at least one communication from the Tx end user to a single destination at the server, wherein the single destination is operative to receive all communications including an intended destination defined by applying a predetermined rule to a unique Tx end user identifier.

16. A method according to claim 15 wherein the communication comprises an email communication having a “to” field, the destination comprises a default auto email, and the intended destination includes an indication, in the “to” field, of a function of a unique Tx end user identifier.

17. A method according to claim 1 wherein said receiving an indication of a known destination comprises receiving a “reply” generated by an end user using an app associated with the server which is operative to send communications to end users and to provide the end users with a “reply” option.

18. A method according to claim 1 wherein said “reply” option comprises a “call” virtual button thereby enabling an end user who has received a communication via the app to initiate a responsive telephone call by a single click and wherein, responsive to pressing of the “call” virtual button by at least one first end user who has received a communication via the app from a second end user, the system server accesses a telephone number of the second end user and interacts with the first end user's communication device to establish a telephone call from the first user to the second user.

19. A multi-modality electronic communication system for communication via end-user selected communication modalities, the system comprising:
computer-implemented memory including at least one memory table operative to store, for each individual end user from among a multiplicity of end users, a plurality of destinations via which the individual end user receives communications via a corresponding plurality of communication modalities;
a server including a processor configured to access said at least one table and operative for:
receiving at least one communication from at least one Tx client processor serving a Tx end user, the communication including:
content which the Tx end user wishes to send to an Rx end user; and
an indication of a known destination of an Rx end user, when a first communication modality is employed,
extracting said known destination from said communication and retrieving from the table, a retrieved destination other than said known destination via which the Rx end user receives communications via a second communication modality other than the first communication modality; and
interacting with communication equipment operative in accordance with said second communication modality so as to cause the communication equipment to send said content to the Rx end user via the second communication modality to the retrieved destination.

20. A computer program product, comprising a non-transitory tangible computer readable medium having computer readable program code embodied therein, said computer readable program code adapted to be executed to implement a multi-modality electronic communication method for communication via end-user selected communication modalities, the method comprising:
at a server including a processor having access to at least one memory table operative to store, for each individual end user from among a multiplicity of end users, a plurality of destinations via which the individual end user receives communications via a corresponding plurality of communication modalities:
receiving at least one communication from at least one Tx client processor serving a Tx end user, the communication including:
content which the Tx end user wishes to send to an Rx end user; and
an indication of a known destination of an Rx end user, when a first communication modality is employed:
extracting said known destination from said communication and retrieving from the table, a retrieved destination other than said known destination via which the Rx end user receives communications via a second communication modality other than the first communication modality; and
sending said content to the Rx end user via the second communication modality to the retrieved destination.
